(19) United States
(12) Patent Application Publication
(10) Pub. No.: US 2012/0113518 A1
(43) Pub. Date: May 10, 2012

(54) DIFFRACTION GRATING LENS AND IMAGE CAPTURE APPARATUS USING THE SAME

(76) Inventors: Takamasa Ando, Osaka (JP); Seiji Nishiwaki, Hyogo (JP); Tsuguhiro Korenaga, Osaka (JP)

(21) Appl. No.: 13/126,591

(22) PCT Filed: Oct. 26, 2010
(86) PCT No.: PCT/JP2010/006324

§ 371 Date: Apr. 28, 2011

(30) Foreign Application Priority Data
Nov. 2, 2009 (JP) 2009-252254

(51) Int. Cl. G02B 5/18

(52) U.S. Cl. 359/571

(57) ABSTRACT

A diffraction grating lens of the present invention includes a lens base 51 having a surface 51b obtained by providing a diffraction grating 52 on a base shape. The diffraction grating 52 includes a plurality of zones 61A and 61B and a plurality of first diffraction steps 65A and second diffraction steps 65B located between the plurality of zones; the lens base is made of a first material whose refractive index is n₁(λ) at a working wavelength λ; and the first diffraction steps 65A and the second diffraction steps 65B have substantially the same height d. The height d satisfies Expression (1) below, where m denotes a diffraction order. A first surface 66A on which tips 63A of the first diffraction steps 65A are located and a second surface 66B on which tips 63B of the second diffraction steps 65B are located are at different positions from each other on an optical axis 53.

$$d = \frac{m \cdot λ}{{n}_{1} ( λ ) - 1} \qquad ( 1 )$$

### TECHNICAL FIELD

The present invention relates to a diffraction optical lens (diffraction optical element) for condensing or diverging light by utilizing diffraction phenomenon, and an image capture apparatus using the same.

### BACKGROUND ART

A diffraction optical element including a diffraction grating provided on a lens base for condensing or diverging light by utilizing diffraction phenomenon is called a diffraction grating lens. It is widely known that a diffraction grating lens is good at correcting aberrations of a lens such as field curvature and chromatic aberration (misalignment of convergence points between different wavelengths). This is because a diffraction grating has dispersiveness that is inverse to the dispersiveness caused by the optical material (inverse dispersiveness) or has dispersiveness that is deviant from the linearity of dispersion of the optical material (abnormal dispersiveness). Therefore, a diffraction grating lens, combined with an ordinary optical element, exerts significant chromatic aberration-correcting capability.

In a case where a diffraction grating is used in an image capture optical system, as compared to an image capture optical system formed only by an aspherical lens, it is possible to obtain the same capacity by a smaller number of lenses. Therefore, it is possible to reduce the manufacturing cost of an image capture optical system and to shorten the optical length, thus allowing for reduction in height.

Referring to FIGS. 18(a) to 18(c), a conventional method for designing the shape of a diffraction grating lens will be described. A diffraction grating lens is designed primarily by the phase function method or the high refractive index method. Herein, a designing method using the phase function method will be described. The same results are obtained eventually also when the design is done by a high refractive index method.

The shape of a diffraction grating lens is formed by the base shape of the lens base on which the diffraction grating is provided and the shape of the diffraction grating. FIG. 18(a) shows an example where the surface shape of the lens base is an aspherical shape Sb, and FIG. 18(b) shows an example of a shape Sp1 of the diffraction grating. The shape Sp1 of the diffraction grating shown in FIG. 18(b) is determined by a phase function. The phase function is shown by Expression (5) below.

$$φ ( r ) = \frac{2 π}{{λ}_{0}} ψ ( r ) \\ ψ ( r ) = {a}_{1} r + {a}_{2} {r}^{2} + {a}_{3} {r}^{3} + {a}_{4} {r}^{4} + {a}_{5} {r}^{5} + {a}_{6} {r}^{6} + … + {a}_{i} {r}^{i} \\ ( {r}^{2} = {x}^{2} + {y}^{2} ) \qquad ( 5 )$$

Herein, φ(r) is the phase function, Ψ(r) is the optical path difference function (z=Ψ(r)), r is the distance in the radial direction from the optical axis, λ₀ is the design wavelength, and a1, a2, a3, a4, a5, a6, . . . , ai are coefficients.

In the case of a diffraction grating utilizing first-order diffraction light, the curve of the phase difference function is cut into a piece each time the phase from the reference point (center) is equal to 2 nπ (n is a natural number greater than or equal to 1) in the phase function φ(r) as shown in FIG. 18(b). The shape Sbp1 of the diffraction grating surface shown in FIG. 18(c) is determined by adding the shape Sp1 of the curve of the phase difference function which has been cut into pieces of 2 nπ to the aspherical shape Sb of FIG. 18(a). The relationship of Expression 5 is used for the conversion from the phase difference function to the optical path difference function.

Where the shape Sbp1 of the diffraction grating surface shown in FIG. 18(c) is provided on an actual lens base, the diffraction effect is obtained if the step height 161 between zones satisfies Expression (1) below.

$$d = \frac{m \cdot λ}{{n}_{1} ( λ ) - 1} \qquad ( 1 )$$

Herein, m is the design order (m=1 for first-order diffraction light), λ is the working wavelength, d is the step height of the diffraction grating, and n₁(λ) is the refractive index of the lens material of the lens base at the working wavelength λ. The refractive index of the lens material has wavelength dependency, and is a function of the wavelength. With such a diffraction grating that satisfies Expression (1), the phase difference on the phase function is 2π between the base and the tip of the zone, and the optical path difference for light at the working wavelength λ is an integral multiple of the wavelength. Therefore, the diffraction efficiency of first-order diffraction light of light at the working wavelength (hereinafter referred to as the “first-order diffraction efficiency”) can be made substantially 100%. As the wavelength λ changes, the value of d with which the diffraction efficiency is 100% changes in accordance with Expression (1). Conversely, if the value of d is fixed, the diffraction efficiency will not be 100% at wavelengths other than a wavelength λ that satisfies Expression (1).

However, where a diffraction grating lens is used in a general photograph-taking application, it is necessary to diffract light over a wide wavelength range (e.g., the visible light range from a wavelength of about 400 nm to about 700 nm, etc.). As a result, if a visible light beam 173 enters a diffraction grating lens including a lens base 171 and a diffraction grating 172 provided on the lens base 171, there occurs diffraction light 176 of an unnecessary order (hereinafter referred to also as the “unnecessary-order diffraction light”) in addition to first-order diffraction light 175 which is of light at the wavelength determined as the working wavelength λ, as shown in FIG. 19. For example, if the wavelength with which the step height d is determined is set to the green wavelength (e.g., 540 nm), although the first-order diffraction efficiency at the green wavelength is 100% and there occurs no unnecessary-order diffraction light 176 of the green wavelength, the first-order diffraction efficiency is not 100% at the red wavelength (e.g., 640 nm) or the blue wavelength (e.g., 440 nm) and there occurs zero-order diffraction light of red or second-order diffraction light of blue. The zero-order diffraction light of red or the second-order diffraction light of blue is the unnecessary-order diffraction light 176, which may spread across the image surface in the form of a flare or a ghost to deteriorate the image or may lower the MTF (Modulation Transfer Function) characteristics.

Patent Document No. 1 discloses an optical adjustment film 181 which is provided on the surface of the lens base 171 with the diffraction grating 172 formed thereon and which is made of an optical material having a refractive index and a refractive index dispersion different from those of the lens base, as shown in FIG. 20. Patent Document No. 1 discloses that it is possible to reduce the wavelength dependency of the diffraction efficiency, to reduce the unnecessary-order diffraction light and to suppress flare due to unnecessary-order diffraction light, by setting the refractive index of the base 171 with the diffraction grating 172 formed thereon and the refractive index of the optical adjustment film 181 formed so as to cover the diffraction grating 172 so as to meet a specific condition.

Patent Document No. 2 discloses a method for obtaining the absolute quantity of, and removing, the unnecessary-order diffraction light 176 through fitting by the least squares method from the two-dimensional point spread of the unnecessary-order diffraction light 176 in a photograph-taking application with a camera using a general diffraction grating lens of FIG. 19.

Patent Document No. 3 discloses a method where if there are saturated pixels in a first frame of a photograph, a second frame of the photograph is taken so that those pixels are not saturated, wherein the absolute quantity of the unnecessary-order diffraction light 176 is obtained from the exposure time adjustment value so as to remove the unnecessary-order diffraction light 176.

### CITATION LIST

### Patent Literature

Patent Document No. 1: Japanese Laid-Open Patent Publication No. 09-127321
Patent Document No. 2: Japanese Laid-Open Patent Publication No. 2005-167485
Patent Document No. 3: Japanese Laid-Open Patent Publication No. 2000-333076

### SUMMARY OF INVENTION

### Technical Problem

The present inventors have found that there occurs fringe flare light which is different from the unnecessary-order diffraction light 176 described above as the zone pitch on the diffraction grating surface of the diffraction grating lens is decreased or if an object of very high light intensity is photographed. It has not been known that such fringe flare light occurs with a diffraction grating lens. The present inventor also found that fringe flare light may possibly significantly lower the quality of a photographed image under particular conditions.

The present invention has been made in order to solve these problems, and has an object to provide a diffraction grating lens with which the occurrence of fringe flare light can be suppressed, and an image capture apparatus using the same.

### Solution to Problem

A diffraction grating lens of the present invention includes a lens base having a surface obtained by providing a diffraction grating on a base shape, wherein: the diffraction grating includes a plurality of zones in an area within a lens diameter of the lens base, and a plurality of diffraction steps located between the plurality of zones; the lens base is made of a first material whose refractive index is n₁(λ) at a working wavelength λ; the plurality of diffraction steps have substantially the same height d; the height d satisfies Expression (1) below, where m denotes a diffraction order;

$$d = \frac{m \cdot λ}{{n}_{1} ( λ ) - 1} \qquad ( 1 )$$

the plurality of diffraction steps include a plurality of first diffraction steps and at least one second diffraction step adjacent to at least one of the plurality of first diffraction steps; tips of the plurality of first diffraction steps are located on a first surface obtained by shifting the base shape parallelly in an optical axis direction of the diffraction grating, and a tip of the at least one second diffraction step is located on a second surface obtained by shifting the base shape parallelly in the optical axis direction; and the first surface and the second surface are at different positions from each other on the optical axis.

A diffraction grating lens of the present invention includes: a lens base having a surface obtained by providing a diffraction grating on a base shape; and an optical adjustment film provided so as to cover the surface of the lens base, wherein: the diffraction grating includes a plurality of zones in an area within a lens diameter of the lens base, and a plurality of diffraction steps located between the plurality of zones; the lens base is made of a first material whose refractive index is n₁(λ) at a working wavelength λ; the optical adjustment film is made of a second material whose refractive index is n₂(λ) at the working wavelength λ; the plurality of diffraction steps have substantially the same height d; the height d satisfies Expression (2) below, where m denotes a diffraction order;

$$d = \frac{m \cdot λ}{{n}_{1} ( λ ) - {n}_{2} ( λ )} \qquad ( 2 )$$

the plurality of diffraction steps include a plurality of first diffraction steps and at least one second diffraction step adjacent to at least one of the plurality of first diffraction steps; tips of the plurality of first diffraction steps are located on a first surface obtained by shifting the base shape parallelly in an optical axis direction of the diffraction grating, and a tip of the at least one second diffraction step is located on a second surface obtained by shifting the base shape parallelly in the optical axis direction; and the first surface and the second surface are at different positions from each other on the optical axis.

In a preferred embodiment, the plurality of diffraction steps include a plurality of second diffraction steps; and the first diffraction steps and the second diffraction steps are arranged so as to alternate with each other.

In a preferred embodiment, an interval L on the optical axis between the first surface and the second surface satisfies Expression (3) below.

0.4d≦L≦0.9d (3)

In a preferred embodiment, an interval L on the optical axis between the first surface and the second surface satisfies Expression (4) below.

0.4d≦L≦0.6d (4)

In a preferred embodiment, an interval L on the optical axis between the first surface and the second surface satisfies L=0.5d.

In a preferred embodiment, the plurality of diffraction steps include a plurality of second diffraction steps; and sets of first diffraction steps, each set including i (i is an integer of 2 or more) consecutively-arranged first diffraction steps, and sets of second diffraction steps, each set including j (j is an integer of 2 or more) consecutively-arranged second diffraction steps are arranged so as to alternate with each other.

In a preferred embodiment, the working wavelength is a wavelength in a visible light range and substantially satisfies Expression (2) for wavelengths across an entire visible light range.

A diffraction grating lens of the present invention includes a lens base having a surface obtained by providing a diffraction grating on a base shape, wherein: the diffraction grating includes a plurality of zones and a plurality of diffraction steps located between the plurality of zones; the lens base is made of a first material whose refractive index is n₁(λ) at a working wavelength λ; the plurality of diffraction steps each have a height d represented by Expression (1) below, where m denotes a diffraction order; and

$$d = \frac{m \cdot λ}{{n}_{1} ( λ ) - 1} \qquad ( 1 )$$

the plurality of zones include first, second and third zones adjacent to one another, wherein the second zone is sandwiched between the first and third zones, the first zone and the second zone have generally the same width, and a width of the second zone is narrower than a width of the first zone.

An image capture apparatus of the present invention includes: any of the diffraction grating lenses set forth above; and an image capture element.

### Advantageous Effects of Invention

According to the present invention, the tips of the plurality of first diffraction steps are located on the first surface which is obtained by shifting the base shape parallelly in the optical axis direction of the diffraction grating, and the tip of the at least one second diffraction step is located on the second surface which is obtained by shifting the base shape parallelly in the optical axis direction; and the first surface and the second surface are at different positions from each other on the optical axis. Thus, as the diffraction grating includes two types of zones having different zone widths and fringe flares occurring from the two types of zones having different zone widths interfere with each other, the occurrence of fringe flare is suppressed.

Using an image capture apparatus including a diffraction grating lens of the present invention, it is possible to obtain an image with little fringe flare light even when photographing an intense light source.

### BRIEF DESCRIPTION OF DRAWINGS

FIG. 1 (a) is a cross-sectional view of a diffraction grating lens according to a first embodiment of the present invention, and (b) is a cross-sectional view showing, on an enlarged scale, the vicinity of a diffraction grating.

FIG. 2 (a) to (c) are graphs showing a method for deriving the shape of the diffraction grating surface of a diffraction grating lens according to the present invention, wherein (a) is a graph showing the base shape, (b) is a graph showing the phase difference function, and (c) is a graph showing the surface shape of the diffraction grating.

FIG. 3 A graph illustrating the reason why the fringe flare is suppressed with the diffraction grating lens shown in FIG. 1.

FIG. 4 A graph showing the surface shape of the diffraction grating with diffraction steps provided at positions different from the diffraction grating shown in FIG. 2(c).

FIG. 5 (a) to (c) are schematic diagrams showing positions of zones in the first embodiment.

FIG. 6 (a) and (b) are cross-sectional views of the diffraction grating lens according to a second embodiment of the present invention.

FIG. 7 A cross-sectional view of an image capture apparatus according to an embodiment of the present invention.

FIG. 8 (a) and (b) are a cross-sectional view and a plan view, respectively, of a stacked-type optical system according to an embodiment of the present invention, and (c) and (d) are a cross-sectional view and a plan view, respectively, of a stacked-type optical system according to another embodiment of the present invention.

FIG. 9A (a) to (e) are schematic diagrams showing positions of diffraction steps of Example 1 .

FIG. 9B (f) to (j) are schematic diagrams showing positions of diffraction steps of Example 1.

FIG. 10A (a) to (f) each show a two-dimensional image obtained at the focal plane when a plane wave having a wavelength of 538 nm is made to enter the diffraction grating lens of Example 1 from a field angle of 60°.

FIG. 10B (g) to (j) each show a two-dimensional image obtained at the focal plane when a plane wave having a wavelength of 538 nm is made to enter the diffraction grating lens of Example 1 from a field angle of 60°.

FIG. 11 A graph showing the relationship between the amount of shift between positions of diffraction steps of Example 1 and the fringe flare maximum intensity percentage.

FIG. 12 A schematic diagram showing positions of diffraction steps of Example 2.

FIG. 13 (a) to (e) each show a two-dimensional image obtained at the focal plane when a plane wave having a wavelength of 538 nm is made to enter the diffraction grating lens of Example 2 from a field angle of 60°.

FIG. 14 A graph showing the relationship between the amount of shift between positions of diffraction steps of Example 2 and the fringe flare maximum intensity percentage.

FIG. 15 A schematic diagram showing positions of diffraction steps of Example 3.

FIG. 16 (a) to (e) each show a two-dimensional image obtained at the focal plane when a plane wave having a wavelength of 538 nm is made to enter the diffraction grating lens of Example 3 from a field angle of 60°.

FIG. 17 A graph showing the relationship between the amount of shift between positions of diffraction steps of Example 3 and the fringe flare maximum intensity percentage.

FIG. 18 (a) to (c) are graphs showing a conventional method for deriving the shape of the diffraction grating surface of a diffraction grating lens, wherein (a) is a graph showing the base shape, (b) is a graph showing the phase difference function, and (c) is a graph showing the surface shape of the diffraction grating.

FIG. 19 A diagram showing how unnecessary diffraction light occurs with a conventional diffraction grating lens.

FIG. 20 A cross-sectional view showing a conventional diffraction grating lens including a lens base and an optical adjustment film provided on the lens base.

FIG. 21 A diagram showing a zone of a diffraction grating as seen from an optical axis direction.

FIG. 22 A schematic diagram showing how fringe flare occurs on an image capture element onto which a bundle of rays which have passed through a zone are condensed.

FIG. 23 (a) is an example of an image taken by an image capture apparatus having a conventional diffraction grating lens, and (b) is an example of an image obtained by enlarging a portion of the image shown in (a), illustrating how fringe flare occurs.

### DESCRIPTION OF EMBODIMENTS

First, fringe flare light which is caused by a diffraction grating lens will be discussed, as discovered by the present inventor.

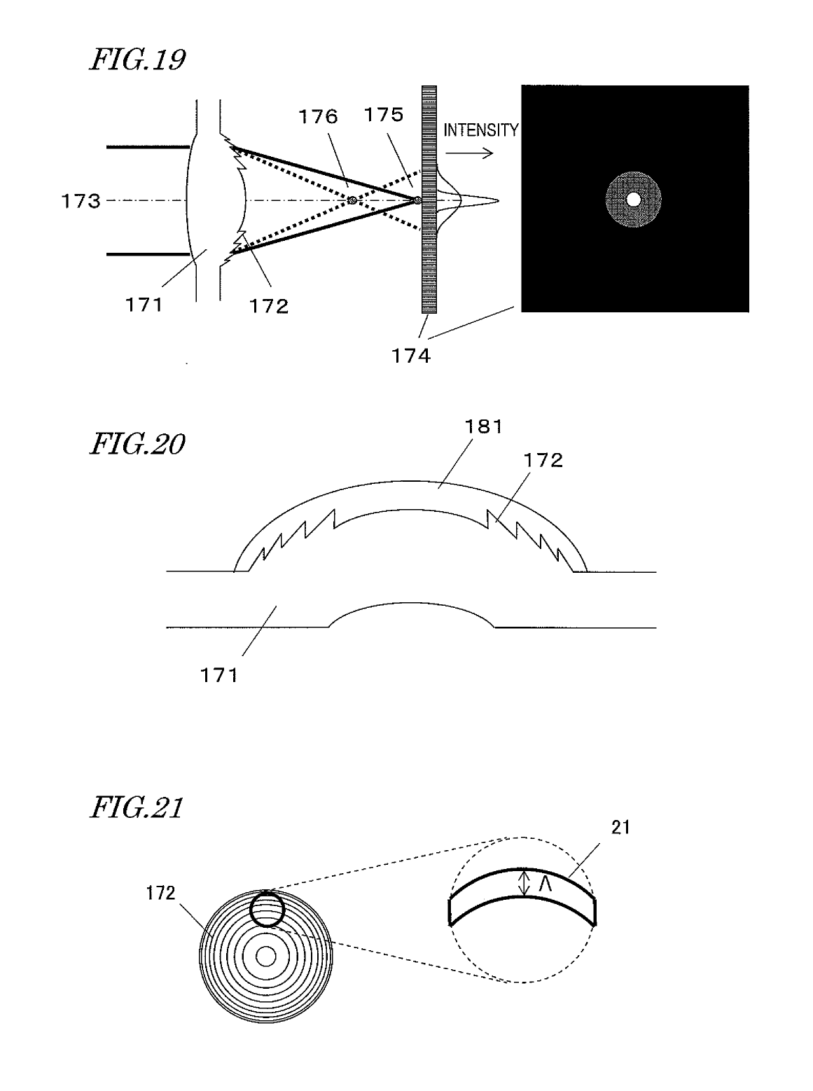

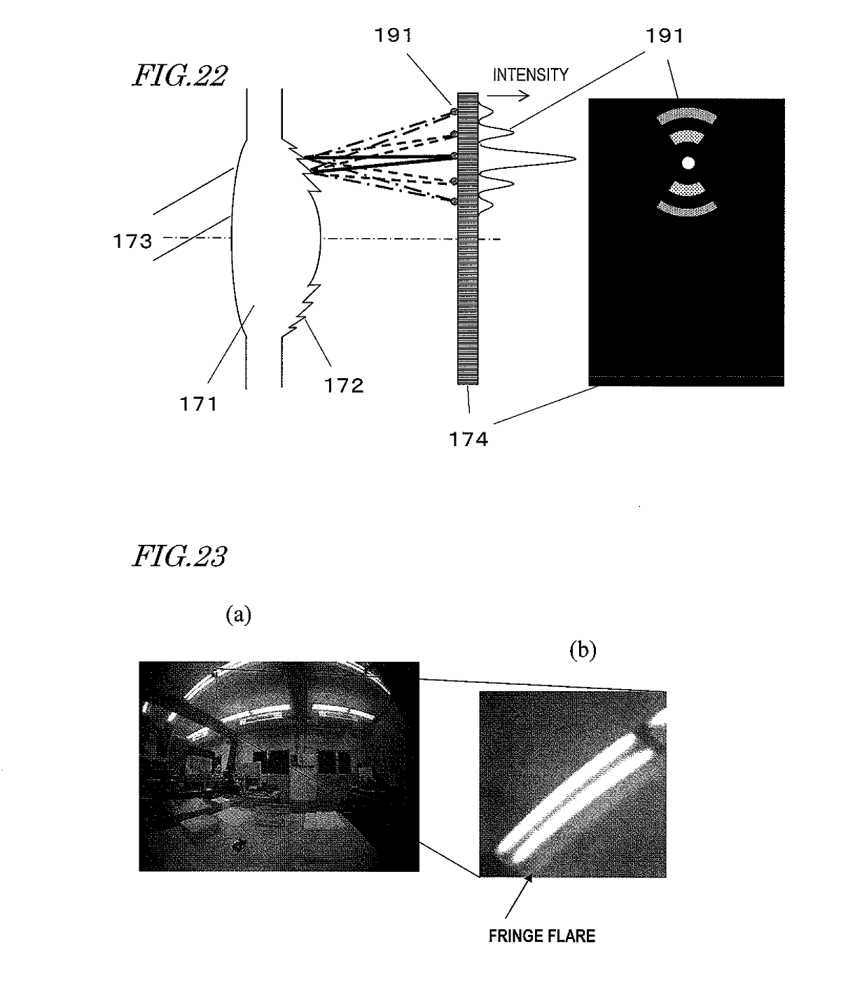

As shown in FIG. 21, each zone 21 is sandwiched between diffraction steps arranged in a concentric pattern in a diffraction grating lens including a diffraction grating 172 provided thereon. Therefore, light passing through two adjacent zones 21 are separated from each other by a diffraction step provided between the wave fronts. Light passing through each zone 21 can be regarded as light passing through a slit having a width of the pitch A of the zone 21. When the pitch A of the zone 21 is reduced, light passing through the diffraction grating lens can be regarded as light passing through very narrow slits arranged in a concentric pattern, and light wave fronts spread out in the vicinity of the diffraction steps. FIG. 22 schematically shows how light enters the lens base 171 including the diffraction grating 172 provided thereon, and how the output light is diffracted by the diffraction grating 172.

Typically, light passing through slits which block light with very small intervals forms diffraction fringes at a point of observation at infinity. This is called Fraunhofer diffraction. This diffraction phenomenon occurs also at a finite distance (focal plane) by including a lens system having a positive focal distance.

The present inventor confirmed, by image evaluation using an actual lens, that as the pitch Λ of the zones 21 decreases, light passing through the zones 21 interfere with each other, resulting in fringe flare 191 which has a shape like a butterfly with its wings spread out as shown in FIG. 22.

It was also found that this fringe flare appears more pronounced when the image capture optical system receives an amount of light incident thereupon that is even larger than an amount of incident light which causes unnecessary-order diffraction light conventionally known in the art, and that while the unnecessary-order diffraction light does not occur for particular wavelengths, the fringe flare light occurs across the entire working wavelength range including the design wavelength.

The fringe flare spreads on the image to be larger than the unnecessary-order diffraction light, thus deteriorating the image quality. Particularly, under a violent environment with a high contrast ratio, e.g., where a bright object such as a light is photographed against a completely dark background such as at night, the fringe flare light 191 is particularly conspicuous and problematic. Since the fringe flare light 191 occurs with a clearly-defined bright/dark fringe pattern, it is more conspicuous and problematic than the unnecessary-order diffraction light 176.

FIG. 23(a) shows an example of an image taken by using an image capture apparatus including a conventional diffraction grating lens. The image shown in FIG. 23(a) is an image of a room where fluorescent lamps are lit. FIG. 23(b) is an enlarged image of a portion of the image shown in FIG. 23(a) in the vicinity of fluorescent lamps. As shown in FIG. 23(b), the bright light in the vicinity of the lower portion of the fluorescent lamps is the fringe flare.

In order to solve this problem, the present inventor has conceived a diffraction optical element having a novel structure, and an image capture apparatus using the same. Embodiments of the diffraction grating lens of the present invention will now be described with reference to the drawings.

### First Embodiment

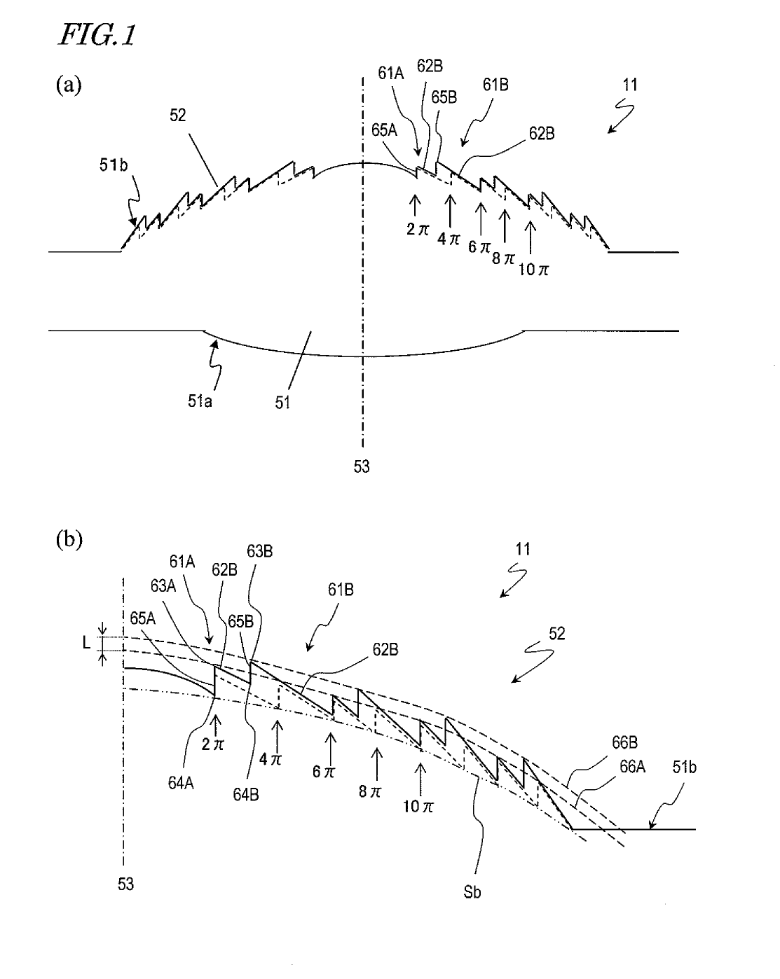

FIG. 1(a) is a cross-sectional view showing a diffraction grating lens according to a first embodiment of the present invention. A diffraction grating lens 11 of the first embodiment includes a lens base 51. The lens base 51 has a first surface 51a and a second surface 51b, and a diffraction grating 52 is provided on the second surface 51b.

While the diffraction grating 52 is provided on the second surface 51b in the present embodiment, it may be provided on the first surface 51a or may be provided on both the first surface 51a and the second surface 51b.

While the base shape of the first surface 51a and the second surface 51b is an aspherical shape in the present embodiment, the base shape may be a spherical or flat-plate shape. The base shape of the first surface 51a and that of the second surface 51b may be the same or different from each other. While each of the base shape of the first surface 51a and that of the second surface 51b is a convex aspherical shape, it may be a concave aspherical shape. Moreover, one of the base shape of the first surface 51a and that of the second surface 51b may be convex with the other being concave.

In the present specification, the “base shape” refers to the shape, as designed, of the surface of the lens base 51 before the shape of the diffraction grating 52 is applied thereto. If a structure such as the diffraction grating 52 is not provided on the surface, the surface of the lens base 51 has the base shape. Since a diffraction grating is not provided on the first surface 51a in the present embodiment, the base shape of the first surface 51a is the surface shape of the first surface 51a and is an aspherical shape.

On the other hand, the second surface 51b is formed by providing the diffraction grating 52 on the base shape. Since the diffraction grating 52 is provided on the second surface 51b, the second surface 51b of the lens base 51 is not an aspherical shape with the diffraction grating 52 provided thereon. However, since the diffraction grating 52 has a shape based on a predetermined condition as will be described below, the base shape of the second surface 51b can be specified by subtracting the shape of the diffraction grating 52 from the shape of the second surface 51b with the diffraction grating 52 provided thereon.

The diffraction grating 52 has a plurality of zones 61A and 61B and a plurality of diffraction steps 65A and 65B, and is provided with at least one diffraction step 65A, 65B between the zones 61A and 61B. The zones 61A and 61B are each a ring-shaped protrusion sandwiched between the diffraction steps 65A and 65B. In the present embodiment, the zones 61A and 61B are arranged in a concentric pattern about an optical axis 53 of the aspherical shape of the base shape of the first surface 51a and the base shape of the second surface 51b. That is, the optical axis of the diffraction grating 52 coincides with the optical axis 53 of the aspherical surface. The zones 61A and 61B do not need to be arranged in a concentric pattern. However, in order to realize desirable aberration characteristics in an optical system for image-capture applications, it is preferred that the zone shapes of the zones 61A and 61B are in rotational symmetry about the optical axis 53.

As shown in FIG. 1(a), of the diffraction steps 65A and 65B of the diffraction grating 52, the diffraction step 65B is provided at a position other than a position where the phase difference from the reference point in the phase function is 2 nmπ as opposed to the conventional technique, and the diffraction step 65A is provided at a position where the phase difference from the reference point in the phase function is 2 nmπ as in the conventional technique. Here, n is a positive integer, and m is the diffraction order. While the diffraction order itself is defined by 0, a positive or negative integer, no diffraction occurs if the diffraction order is 0. Therefore, in the present invention, m is a positive or negative integer.

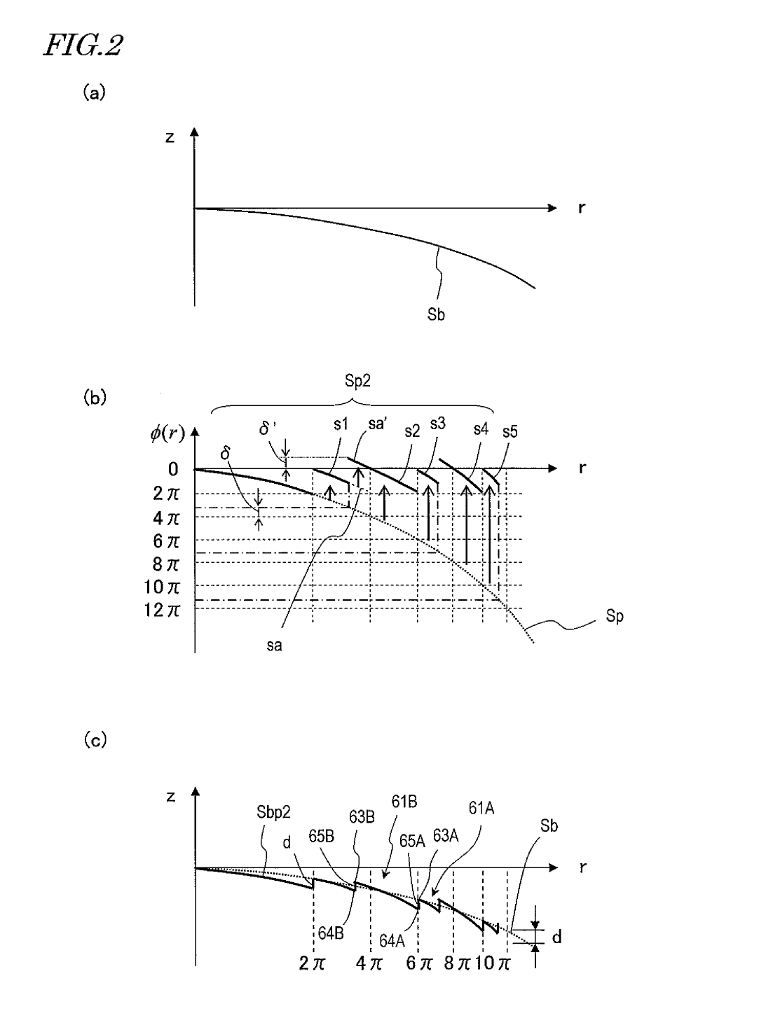

Referring to FIGS. 2(a) to 2(c), the structure of the diffraction grating 52, and a method for designing the shape of the second surface 51b having the diffraction grating 52 will be described.

As described above, the shape of the second surface 51b of the diffraction grating lens 11 is formed by the base shape of the lens base 51 on which the diffraction grating is provided, and the shape of the diffraction grating 52 itself provided on the base shape. FIG. 2(a) shows an example where the base shape of the second surface 51b is the aspherical shape Sb, and FIG. 2(b) shows an example of a shape Sp2 of the diffraction grating 52. The shape Sp2 of the diffraction grating shown in FIG. 2(b) is determined by the phase function. The phase function is represented by Expression (5) above.

$$φ ( r ) = \frac{2 π}{{λ}_{0}} ψ ( r ) \\ ψ ( r ) = {a}_{1} r + {a}_{2} {r}^{2} + {a}_{3} {r}^{3} + {a}_{4} {r}^{4} + {a}_{5} {r}^{5} + {a}_{6} {r}^{6} + … + {a}_{i} {r}^{i} \\ ( {r}^{2} = {x}^{2} + {y}^{2} ) \qquad ( 5 )$$

Herein, φ(r) is the phase function, Ψ(r) is the optical path difference function (z=Ψ(r)), r is the distance in the radial direction from the optical axis, λ₀ is the design wavelength, and a1, a2, a3, a4, a5, a6, ai are coefficients.

Where first-order diffraction light is utilized, i.e., where the shape Sp of the curve of the phase difference function is cut off at positions where the phase difference from the reference point (center) in the phase function φ(r) is 2 nπ and at positions other than 2 nπ, and the cut-off curves are shifted by 2 nπ in the negative direction, as shown in FIG. 2(b). That is, diffraction steps are provided at these positions. As a result, the shape Sp2 of the diffraction grating 52 is formed by the cut-off curve portions s1, s2, s3, s4, s5, . . . , as shown in FIG. 2(b). With a conventional diffraction grating, the curved portion sa indicated by a broken line in FIG. 2(b) would be connected to the curved portion s1 because the phase difference from the reference point is between 2π and 4π. In the present embodiment, however, since cutting is done at positions other than 2 nπ, it is connected, as sa′, to the curved portion s2. The shape Sp2 formed by the cut-off curves of the phase difference function is added to the aspherical shape Sb of FIG. 2(a), thus determining a shape Sbp2 of the diffraction grating surface shown in FIG. 2(c). Note that the conversion from the phase difference function to the optical path difference function is done by using the relationship of Expression (5). The phase function may be Expression (5) including a constant term. In such a case, the reference point is no longer 0, and the positions of the diffraction steps are all shifted by a certain amount in the r direction in FIG. 2(b).

Where the shape Sbp2 of the diffraction grating surface shown in FIG. 2(c) is provided on an actual lens base, the diffraction effect is obtained if the diffraction step height d between zones satisfies Expression (1) below.

$$d = \frac{m \cdot λ}{{n}_{1} ( λ ) - 1} \qquad ( 1 )$$

Herein, m is the design order (m=1 for first-order diffraction light), A is the working wavelength, d is the step height of the diffraction grating, and n₁(λ) is the refractive index of the lens material of the lens base at the working wavelength λ. The refractive index of the lens material has wavelength dependency, and is a function of the wavelength.

Where the diffraction grating lens 11 is used for picture taking, etc., the diffraction grating 52 is designed on the assumption that light of the same working wavelength or working wavelengths in the same wavelength region is incident upon the area within the lens diameter and the light is diffracted on the same diffraction order. Therefore, the step heights d of the diffraction steps 65A and 65B in the area within the lens diameter are designed to be substantially the same value in accordance with Expression (1). The term “substantially the same value” for example means that the step heights d of the diffraction steps 65A and 65B each satisfy Expression (1′) below.

$$0.9 d \leq \frac{m \cdot λ}{{n}_{1} ( λ ) - 1} \leq 1.1 d \qquad ( {1}^{′} )$$

Herein, the lens diameter refers to the diameter of a circular area (lens area) that is obtained by projecting, onto a plane orthogonal to the optical axis, a portion of the diffraction grating lens 11 that is given a predetermined condensing or diverging function.

Note that while the working wavelength λ typically coincides with the design wavelength λ₀, they may be different from each other. The design wavelength used in the phase difference function is, for example, determined to be the middle of the visible light range (e.g., 540 nm) so as to reduce the aberration. In contrast, the working wavelength λ used for the height d of the diffraction step is determined while attaching great importance to the diffraction efficiency, for example. Therefore, where the diffraction efficiency has an asymmetric distribution with respect to the center wavelength over the entire visible light range, the working wavelength λ is in some cases slightly shifted from the middle of the visible light range. In such a case, the working wavelength λ is different from the design wavelength λ₀.

The shape Sbp2 of the diffraction grating surface shown in FIG. 2(c) is the actual shape of the second surface 51b of the lens base 51. Note however that the z direction, i.e., the optical path difference, is dependent on the refractive index difference between the lens base 51 and the medium which is in contact with the lens base 51 and on the wavelength of light used. Since the shape Sp2 formed by the curve of the phase difference function shown in FIG. 2(b) is cut off at positions where the phase difference from the reference point is 2 nπ and at positions other than 2 nπ, the value of the phase function of FIG. 2(b) is converted to the optical path length and added to the surface shape Sb of the lens base shown in FIG. 2(a). In this way, the cut-off positions, i.e., the diffraction steps, are provided at positions where the optical path difference from the base shape at the design wavelength λ₀ is an integral multiple of the wavelength (2 nm on the phase function) and at positions other than an integral multiple (2 nπ on the phase function). Specifically, there are diffraction steps 65A provided at positions that are integral multiples of the wavelength (2 nπ on the phase function, where n=1, 3, 5, . . . ) and diffraction steps 65B provided at positions other than integral multiples (2 nπ on the phase function, where n=2, 4, 6, . . . ) (FIG. 2 shows a case where m=1). The diffraction steps 65A and the diffraction steps 65B are arranged so as to alternate with each other toward the outside from the optical axis 53. The heights of the diffraction steps 65A and the diffraction steps 65B are each the value d corresponding to the phase difference 2π at the design wavelength λ₀. With such a configuration, the diffraction grating 52 includes two types of zones 61A and zones 61B. As a result, between a zone 61A and a zone 61B adjacent to each other, the zone surface 62A and the zone width of the zone 61A are relatively short, whereas the zone surface 62B and the zone width of the zone 61B are relatively long. Thus, as the diffraction grating 52 includes two types of zones 61A and zones 61B having different zone widths or zone surface widths, it is possible to suppress fringe flare. The details will be described later.

FIG. 1(b) is a cross-sectional view showing, on an enlarged scale, the surface 51b of the lens base with the diffraction grating 52 provided thereon. With the design method of providing diffraction steps by cutting off the curved surface of the phase function at positions where the phase difference from the reference point on the phase function is 2 n and at positions other than 2 nπ as described above, it can be said that the surface 51b has the following configuration. As shown in FIG. 1(b), a tip 63A of each zone 61A on the surface 51b is located on a first surface 66A which is obtained by shifting the base shape Sb parallelly in the optical axis direction of the diffraction grating 52. Similarly, a tip 63B of each zone 61B is located on a second surface, different from the first surface, which is obtained by shifting the base shape Sb parallelly in the optical axis direction of the diffraction grating 52. Where the diffraction steps 65B are at positions other than 2 nπ and the phase difference between adjacent diffraction steps 65B is 2 nπ, the tip 63B of each zone 61B is located on the same second surface 66B, different from the first surface 66A, which is obtained by shifting the base shape Sb parallelly in the optical axis direction of the diffraction grating 52. The interval L between the first surface 66A and the second surface 66B on the optical axis of the diffraction grating 52 is less than or equal to the height d of the diffraction step 65A and the diffraction step 65B.

That is, if the tips of the zones are not all located on a single surface which is obtained by shifting the base shape Sb parallelly in the optical axis direction of the diffraction grating 52, there is at least one diffraction step provided at a position other than positions where the phase difference from the reference point on the phase function is 2 nπ, and therefore two adjacent zones with the diffraction step therebetween have different widths.

This similarly applies also to bases 64A of zones 61A and bases 64B of zones 61B. The bases 64A of the zones 61A are located on a curved surface which is obtained by shifting the base shape Sb parallelly in the optical axis direction, and the bases 64B of the zones 61B are located on a curved surface which is obtained by shifting the base shape Sb parallelly in the optical axis direction. Note however that the curved surface on which the bases 64A are located is different from the curved surface on which the bases 64B are located.

With the conventional diffraction grating lens, the diffraction steps are provided by cutting off the phase function at positions where the phase difference from the reference point is 2 nπ, and therefore the tips of the zones are all located on a single curved surface which is obtained by shifting the base shape parallelly in the optical axis direction. Similarly, the bases of the zones are all located on a single curved surface which is obtained by shifting the base shape parallelly in the optical axis direction. Thus, it can be said that the structure of the diffraction grating described above is characteristic of the present invention.

As shown in FIGS. 18(b) and 18(c), with a conventional diffraction grating lens, the widths of the zones gradually narrow toward the outer periphery of the diffraction grating, but three or so continuously adjacent zones have substantially the same width. In contrast, with the diffraction grating lens 11 of the present embodiment, for a zone 61A and two zones 61B sandwiching the zone 61A therebetween, the two zones 61B adjacent to each other sandwiching the zone 61A therebetween have the same width, and the zone 61A sandwiched between the two zones 61B is narrower than the two zones 61B. Herein, being “the same” includes not only cases where the widths of the two zones coincide with each other, but also cases where they do not coincide with each other but the longer zone width is within 1.05 times the shorter zone width.

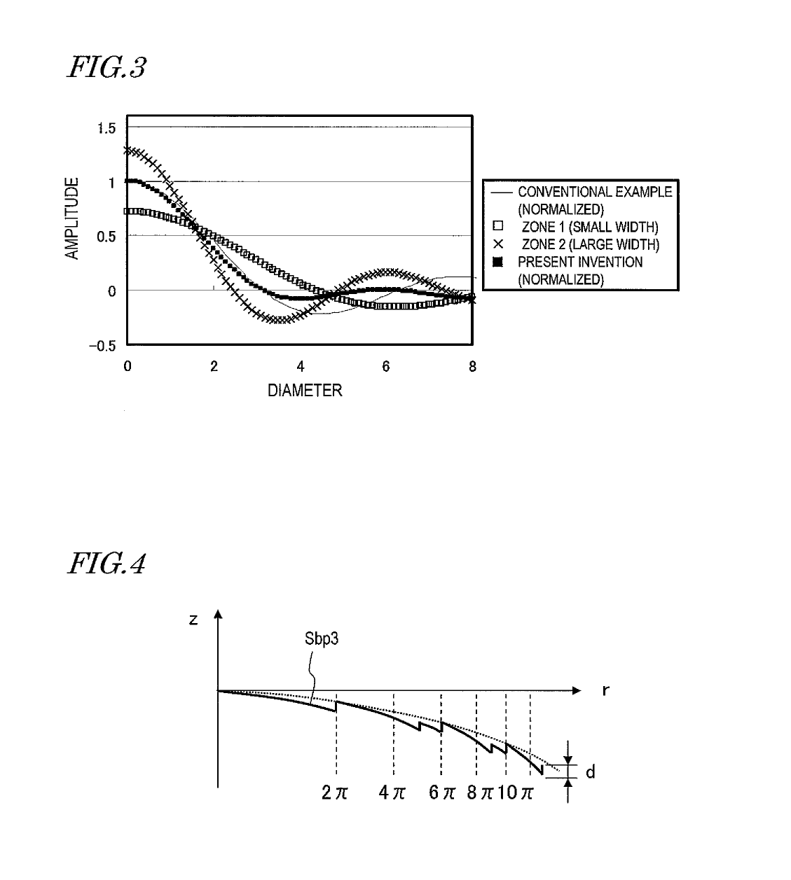

FIG. 3 is a graph illustrating the reason why the fringe flare is reduced with the diffraction grating lens 11 with the diffraction grating 52 provided thereon. As shown in FIG. 3, the wave interval in the radial direction is relatively wide for light of Fraunhofer diffraction (diffraction fringe) from a zone 1 having a narrow zone width, whereas the wave interval in the radial direction is relatively narrow for light of Fraunhofer diffraction from a zone 2 having a wide zone width. Since the amplitude intensity near the center reflects the zone width, the intensity of light of Fraunhofer diffraction from the zone 1 decreases, and the intensity of light of Fraunhofer diffraction from the zone 2 increases. What is obtained by adding together the light of Fraunhofer diffraction from the zone 1 and that from the zone 2 is the light of Fraunhofer diffraction from the diffraction grating of the present embodiment. As can be seen from FIG. 3, since the wave interval in the radial direction of light of Fraunhofer diffraction from the zone 1 is different from that from the zone 2, the waves cancel each other at positions other than those near the center, resulting in an amplitude of light smaller than light of Fraunhofer diffraction obtained by the conventional diffraction grating. That is, the fringe flare is reduced.

As can be seen from the above description, this effect is realized because the diffraction steps are provided at positions where the phase difference from the reference point on the phase function is 2 mπ and positions other than 2 nπ with the width of a zone 61A being different from the width of an adjacent zone 61B. Thus, the diffraction steps 65B can be provided at any positions as long as they are positions where the phase difference is other than 2 nπ.

Preferably, the position of the diffraction step 65B provided at a position where the phase difference from the reference point on the phase function is other than 2 nπ is deviated by π/5 or more, i.e., shifted by ±10% or more from a position of 2 nπ. This is because there is not sufficient effect of interference between two different types of Fraunhofer diffraction light if the amount of shift is within ±10%. More preferably, the amount of shift is in the range of −40% to −90%, and even more preferably in the range of −40% to −60%.

As shown in FIG. 2(b), the amount of shift δ of the diffraction step provided at a position other than 2 nπ on the phase function from a position of 2 nπ coincides with the amount of shift δ′ between the tip of a diffraction step provided at a position of 2 nπ and the tip of a diffraction step provided at a position other than 2 nπ. Therefore, the above-described preferred amount of shift of the diffraction step 65B from a position of 2 nπ can be represented by the amount of shift described above with reference to FIG. 1(b), from the diffraction step d, of the interval L on the optical axis of the diffraction grating 52 between the first surface 66A on which the tips 63A of the zones 61A are located and the second surface 66B on which the tips 63B of the zones 61B are located. Where the interval L on the optical axis of the diffraction grating 52 between the first surface 66A on which the tips 63A of the zones 61A are located and the second surface 66B on which the tips 63B of the zones 61B are located is used, the interval L preferably satisfies 0.4≦d≦0.9d, and more preferably satisfies 0.4d≦L≦0.6d. The reason why these ranges are preferable will be described in Examples below.

It is preferred that the position of the diffraction step 65A provided at a position where the phase difference from the reference point on the phase function is 2 nπ has an amount of shift smaller than ±10% from a position of 2 nπ. This is because if the amount of shift is ±10% or more, the characteristics of the diffraction grating 52 change substantially. For the characteristics of the diffraction grating 52 to be exerted as designed, the amount of shift is preferably as small as possible while it can be machined.

While the diffraction grating lens 11 utilizes first-order diffraction light of the diffraction grating 52 in the present embodiment, second- or higher-order diffraction may be utilized. In such a case, the diffraction steps 65A and 65B are provided at positions where the phase difference from the reference point on the phase function is 2 nmπ and positions other than 2 nmπ, where m is the order of diffraction light to be utilized.

As long as the diffraction step 65B is provided in the diffraction grating 52 at one or more positions, the zones 61A and 61B of different zone widths are formed, and it is therefore possible to obtain the effect of the present invention described above. Note however that it is preferred that the diffraction steps 65B are provided in the area within the lens diameter of the diffraction grating lens 11. Steps provided outside the area do not function as the diffraction steps 65B. For example, there are cases where a lens edge for holding a diffraction grating lens is provided along the outer periphery of a diffraction grating of a lens base. The step formed by this edge does not function as the diffraction step 65B even if it is located at a position where the phase difference from the reference point on the phase function is other than 2 nmπ. That is, it is preferred that the diffraction steps 65B are provided in an area of the diffraction grating 52 other than along the outer periphery edge thereof. If the step formed by the lens edge is located at a position where the phase difference from the reference point on the phase function is other than 2 nmπ, it is preferred that at least another diffraction step 65B is provided in the area within the lens diameter of the diffraction grating lens 11.

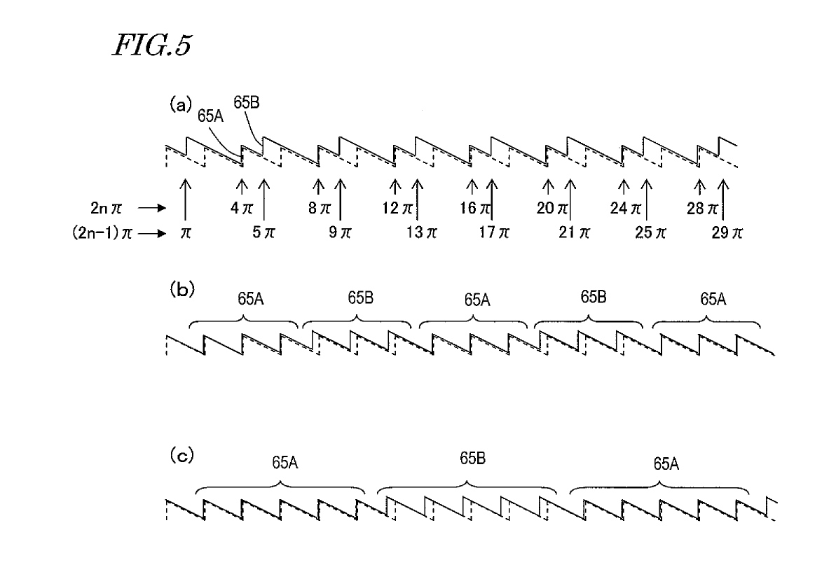

The diffraction steps 65B may be provided at any positions as long as the phase difference from the reference point on the phase function is other than 2 nπ. In FIG. 2(c), the diffraction steps 65B are provided at positions of 3π, 7π, 11π, . . . . However, as shown in FIG. 4, for example, the shape Sbp2 of the diffraction grating surface in which the diffraction steps 65B are provided at positions of 5π, 9π, 13π, . . . , may be provided on the surface 51b of the lens base 51.

As described above, according to the present invention, the diffraction steps 65A and 65B are provided at positions where the phase difference from the reference point on the phase function is 2 nmπ and positions other than 2 nmπ, and the first surface 66A on which the tips 63A of the zones 61A are located and the second surface 66B on which the tips 63B of the zones 61B are located are located at different positions from each other on the optical axis of the diffraction grating 52. Therefore, the width of the zone 61A and the width of the zone 61B can be made different from each other, and the fringe flare can be reduced or made inconspicuous. As a result of an in-depth study, it has been found that the effect of reducing the fringe flare varies depending on the position of the diffraction step 65B.

FIGS. 5(a) to 5(c) are diagrams showing a schematic surface shape of the diffraction grating 52 obtained by a phase function assuming that the phase difference with respect to the radial position changes linearly, so as to facilitate the understanding of a feature of the present invention. In FIGS. 5(a) to 5(c), the broken line shows a surface shape of the diffraction grating 52 obtained when diffraction steps are all provided at positions of 2 nmπ.

According to an in-depth study, it is preferred that the diffraction steps 65A are provided at positions where the phase difference from the reference point on the phase function is 2 nmπ and the diffraction steps 65B are provided at positions where the phase difference is (2 n−1)mπ, as shown in FIG. 5(a), in order to reduce the fringe flare light occurring at positions distant from the primary light-condensing position (FIG. 5(a) is a case where m=1). With such a configuration, Fraunhofer diffraction fringes occurring from two zones of different zone widths interfere with each other, thereby effectively reducing the fringe flare light. This configuration will be described in detail in Example 1 below. In such a case, the diffraction steps 65A and the diffraction steps 65B are arranged alternately.

In order to disperse conspicuous fringe flare light occurring at a specific position over a wide area and make it less conspicuous, it is preferred that sets of diffraction steps 65A, each set including i consecutively-arranged diffraction steps 65A, and sets of diffraction steps 65B, each set including j consecutively-arranged diffraction steps 65B, are arranged so as to alternate with each other, as shown in FIG. 5(b) or 5(c). FIG. 5(b) shows the surface shape of the diffraction grating 52 in a case where i=j=3, and FIG. 5(c) shows the surface shape of the diffraction grating 52 in a case where i=j=4. With such a configuration, there occurs fringe flare light of various fringe intervals, thus decreasing the bright/dark contrast of the fringes, and making the fringe flare inconspicuous. This configuration will be described in detail in Examples 2 and 3.

The numbers i and j of consecutively-arranged diffraction steps 65A and 65B are not limited to any particular number, and the number i of diffraction steps 65A and the number j of diffraction steps 65B may be different from each other. It is preferred that each of i and j is two or more and is less than or equal to ½ the number of zones within the lens diameter. It is preferred that i and j are equal to each other in order to effectively suppress the fringe flare.

Thus, in order to effectively suppress the fringe flare, it is preferred that the distribution density of the diffraction steps 65A and the distribution density of the diffraction steps 65B are generally equal to each other. Specifically, it is preferred that the diffraction grating 52 includes a plurality of diffraction steps 65A and a plurality of diffraction steps 65B, wherein the diffraction steps 65A and the diffraction steps 65B are arranged so as to alternate with each other, or sets of diffraction steps 65A, each set including i (an integer of 2 or more) consecutively-arranged diffraction steps 65A, and sets of diffraction steps 65B, each set including j (an integer of 2 or more) consecutively-arranged diffraction steps 65B, are arranged so as to alternate with each other.

As described above, with the diffraction grating lens of the present embodiment, the diffraction steps are provided at positions where the phase difference from the reference point on the phase function is 2 nπ and at positions other than 2 nπ. Thus, the tips of the diffraction steps at positions where the phase difference is 2 nπ are located on the first surface which is obtained by shifting the base shape parallelly in the optical axis direction of the diffraction grating, and the tips of the diffraction steps at positions where the phase difference is other than 2 nπ are located on the second surface which is obtained by shifting the base shape parallelly in the optical axis direction, wherein the first surface and the second surface are at different positions on the optical axis. Thus, as the diffraction grating includes two types of zones having different zone widths and fringe flares occurring from the two types of zones having different zone widths interfere with each other, the occurrence of fringe flare is suppressed.

In the present embodiment, the diffraction steps 65B provided in the diffraction grating 52 at positions other than 2 nmπ are provided across the entire surface of the second surface 51b of the lens base 51. However, the diffraction steps 65B may be provided at least one position excluding along the outer periphery edge of the diffraction grating, as described above, and may be formed partly, e.g., only near the outer periphery of the second surface 51b or only in a central portion. Particularly, in the lens peripheral portion, the zone pitch is likely to be narrow, and fringe flare light is therefore likely to be pronounced. Therefore, it is possible to sufficiently suppress the fringe flare only by providing the diffraction steps 65B in the lens peripheral portion.

### Second Embodiment

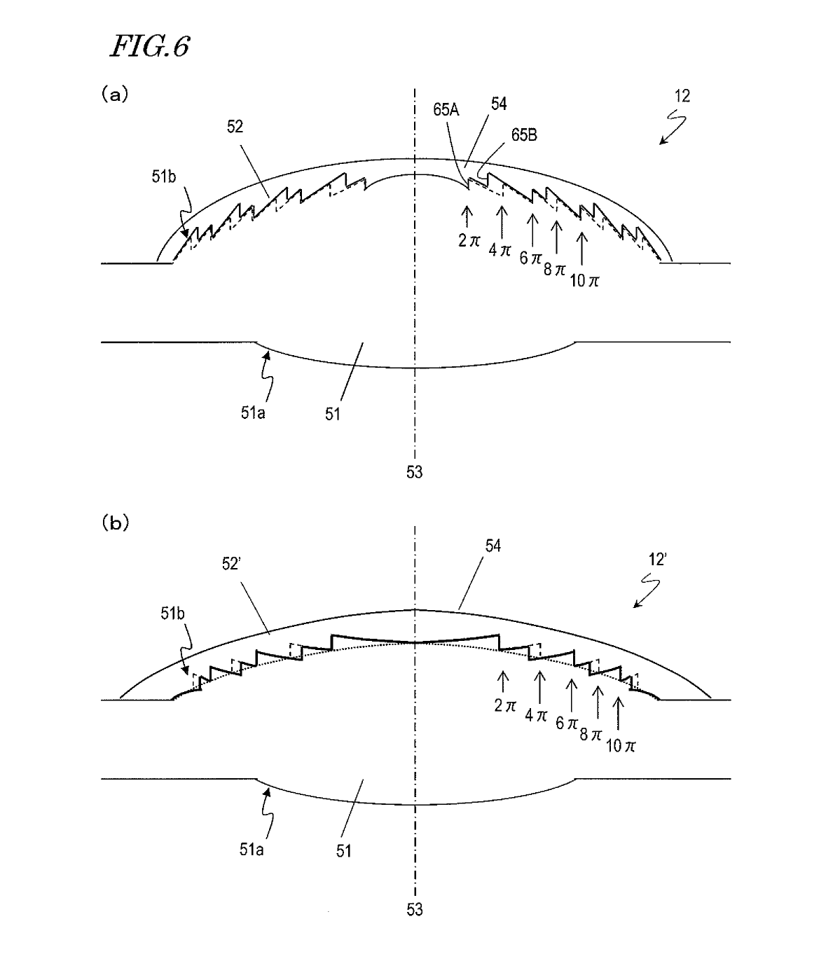

FIG. 6(a) is a cross-sectional view showing a diffraction grating lens according to a second embodiment of the present invention. A diffraction grating lens 12 shown in FIG. 6(a) includes the lens base 51, the diffraction grating 52 provided on the lens base 51, and an optical adjustment film 54 provided on the lens base 51 so as to cover the diffraction grating 52. The lens base 51 has the first surface 51a and the second surface 51b, and the diffraction grating 52 is provided on the second surface 51b. Preferably, the optical adjustment film 54 is provided so as to completely bury the diffraction steps of the diffraction grating 52.

The lens base 51 with the diffraction grating 52 provided thereon has a similar structure to that of the diffraction grating lens 11 of the first embodiment.

As in the first embodiment, the lens base 51 is made of a first material whose refractive index is n₁(λ) at the working wavelength λ. The optical adjustment film 54 is made of a second material whose refractive index is n₂(λ) at the working wavelength λ.

Where d denotes the height of the diffraction steps 65A and 65B of the diffraction grating 52 and m denotes the diffraction order, the diffraction steps 65A and 65B in the area within the lens diameter each have substantially the same height d represented by Expression (2) below.

$$d = \frac{m \cdot λ}{{n}_{1} ( λ ) - {n}_{2} ( λ )} \qquad ( 2 )$$

Preferably, the working wavelength λ is a wavelength in the visible light range, and substantially satisfies Expression (2) for wavelengths λ across the entire visible light range. To substantially satisfy means that the relationship of Expression (2′) below is satisfied, for example.

$$0.9 d \leq \frac{m \cdot λ}{{n}_{1} ( λ ) - {n}_{2} ( λ )} \leq 1.1 d \qquad ( {2}^{′} )$$

In this case, if light of an arbitrary wavelength λ in the visible light range substantially satisfies Expression (2), unnecessary-order diffraction light no longer occurs so that the wavelength dependency of the diffraction efficiency is very small and a high diffraction efficiency is obtained.

In order for light of an arbitrary wavelength λ in the visible light range to substantially satisfy Expression (2), one may employ a combination of a first material whose refractive index is n₁(λ) and a second material whose refractive index is n₂(λ) having such wavelength dependency that d is substantially constant at an arbitrary wavelength λ in the visible light range or within the wavelength range of light to be used. Typically, a material having a high refractive index and a low wavelength dispersion is combined with a material having a low refractive index and a high wavelength dispersion.

More specifically, one may select, as the second material, a material whose wavelength dependency of refractive index exhibits opposite tendency to the wavelength dependency of refractive index of the first material. For example, in the wavelength range of light with which the diffraction optical lens 12 is to be used, the refractive index of the second material is smaller than the refractive index of the first material, and the wavelength dispersiveness of the refractive index of the second material is larger than the wavelength dispersiveness of the refractive index of the first material. That is, the second material is preferably a material having a lower refractive index and a higher dispersiveness than the first material.

The wavelength dispersiveness of the refractive index is represented by the Abbe's number, for example. The larger the Abbe's number is, the smaller the wavelength dispersiveness of the refractive index is. Therefore, it is preferred that the refractive index of the second material is smaller than the refractive index of the first material, and the Abbe's number of the second material is smaller than the Abbe's number of the first material.

Table 1 below shows examples of preferred combinations between the first material and the second material. In Table 1, the refractive index (nd) represents the refractive index at d line, and the Abbe's number (νd) represents the Abbe's number at d line. Note that in Table 1, the first material may be used as the material of the lens base 51 and the second material as the material of the optical adjustment film 54, or the second material may be used as the material of the lens base 51 and the first material as the material of the optical adjustment film 54. In either case, by substantially satisfying Expression (2), the unnecessary-order diffraction light no longer occurs, realizing a high diffraction efficiency across the entire visible light range.

TABLE 1

| | |
|---|---|
| First material | Second material |

| Refractive | Abbe's number | Refractive | Abbe's number |
|---|---|---|---|
| index (nd) | (νd) | index (nd) | (νd) |
| 1.680 | 65 | 1.5247 | 35 |
| 1.623 | 40 | 1.585 | 28 |
| 1.650 | 45 | 1.621 | 30 |

The first material and the second material may each be a composite material including a glass or a resin with inorganic particles dispersed therein. A composite material can be used suitably as the first material and the second material because the refractive index and the wavelength dispersiveness of the composite material as a whole are adjusted by adjusting the type of the inorganic particles, etc., to be dispersed, the particle size thereof, and the amount added thereof.

If the refractive index n₂(λ) is larger than the refractive index n₁(λ), d is a negative value. In such a case, the shape of the second surface 51b of the diffraction grating 52 is obtained by inverting and adding, to the base shape, the phase difference of the phase difference function. FIG. 6(b) shows a structure of a diffraction grating lens 12′where the refractive index n₂(λ) is larger than the refractive index n₁(λ).

Although the diffraction optical lens 12 of the present embodiment differs from the diffraction optical lens 11 of the first embodiment in that the diffraction grating 52 is covered by the optical adjustment film 54, as described above, it can be said that the diffraction optical lens 11 and the diffraction optical lens 12 have the same structure if the optical adjustment film 54 is an air layer. As is clear from the comparison between Expression (2) and Expression (1), the refractive index n₂(λ) of the second material which is typically an optical material is greater than 1, and therefore the step d is larger as compared with the case of the diffraction optical lens 11 of the first embodiment. However, the occurrence of diffraction fringes due to Fraunhofer diffraction and the effect of suppressing fringe flare of the present invention are not dependent on the wavelength. Therefore, even if the diffraction grating is covered by the optical adjustment film 54, the occurrence of fringe flare is suppressed, as in the first embodiment, by the diffraction optical lens 12 of the present embodiment. If Expression (2) is satisfied across the entire working wavelength range, it is possible to reduce flare due to unnecessary-order diffraction light.

### Third Embodiment

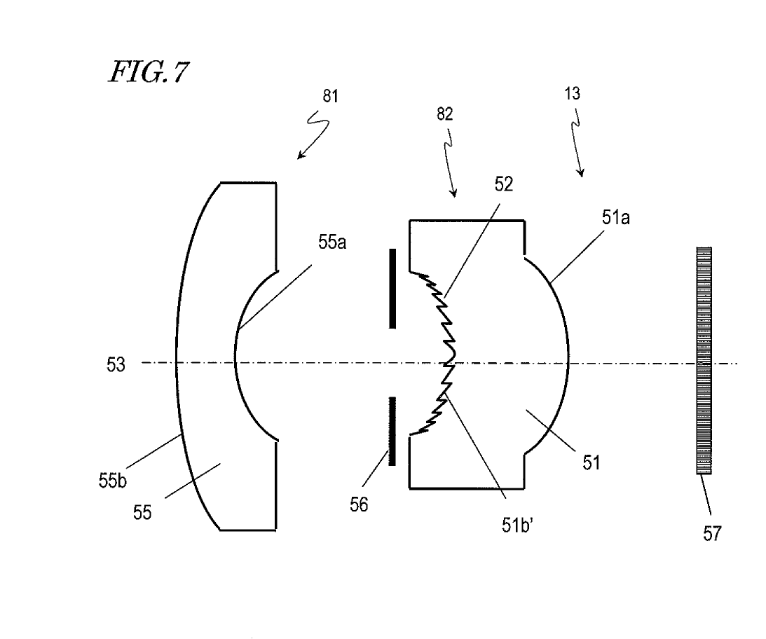

FIG. 7 is a schematic cross-sectional view showing an image capture apparatus according to an embodiment of the present invention. An image capture apparatus 13 includes a lens 81, a diffraction grating lens 82, a diaphragm 56, and an image capture element 57.

The lens 81 includes a lens base 55. A first surface 55a and a second surface 55b of the lens base 55 have a known lens surface shape such as a spherical shape, an aspherical shape, or the like. In the present embodiment, the first surface 55a of the lens base 55 has a concave shape, and the second surface 55b has a convex shape.

A lens 82 includes the lens base 51. The base shape of the first surface 51a and the second surface 51b′ of the lens base 51 have a known lens surface shape such as a spherical shape, an aspherical shape, or the like. In the present embodiment, the first surface 51a has a convex shape, and the second surface 51b′ has a concave shape. The diffraction grating 52 described above in the first embodiment is provided on the second surface 51b′.

Light from an object entering from the second surface 55b of the lens 81 is condensed by the lens 81 and the lens 82, forms an image on the surface of the image capture element 57, and is converted to an electric signal by the image capture element 57.

While the image capture apparatus 13 of the present embodiment includes two lenses, there are no particular limitations on the number of the lenses and the shape of the lens, and the number of lenses provided may be one or three or more. By increasing the number of lenses, it is possible to improve the optical characteristics. Where the image capture apparatus 13 includes a plurality of lenses, the diffraction grating 52 may be provided on any of the plurality of lenses. The surface on which the diffraction grating 52 is provided may be arranged on the object side or on the image capture side, or there may be a plurality of such surfaces. Note however that if a plurality of diffraction gratings 52 are provided, the diffraction efficiency is decreased. Therefore, it is preferred that the diffraction grating 52 is provided only on one surface. The zone shape of the diffraction grating 52 may not necessarily be the concentric arrangement about the optical axis 53. Note however that in order to realize desirable aberration characteristics in an optical system for image-capture applications, it is preferred that the zone shape of the diffraction grating 52 is in rotational symmetry about the optical axis 53. The diaphragm 56 may be absent.

Since the image capture apparatus of the present embodiment includes a diffraction grating lens on which the diffraction grating 52 described above in the first embodiment is provided, it is possible to obtain an image with little fringe flare light even when photographing an intense light source.

### Fourth Embodiment

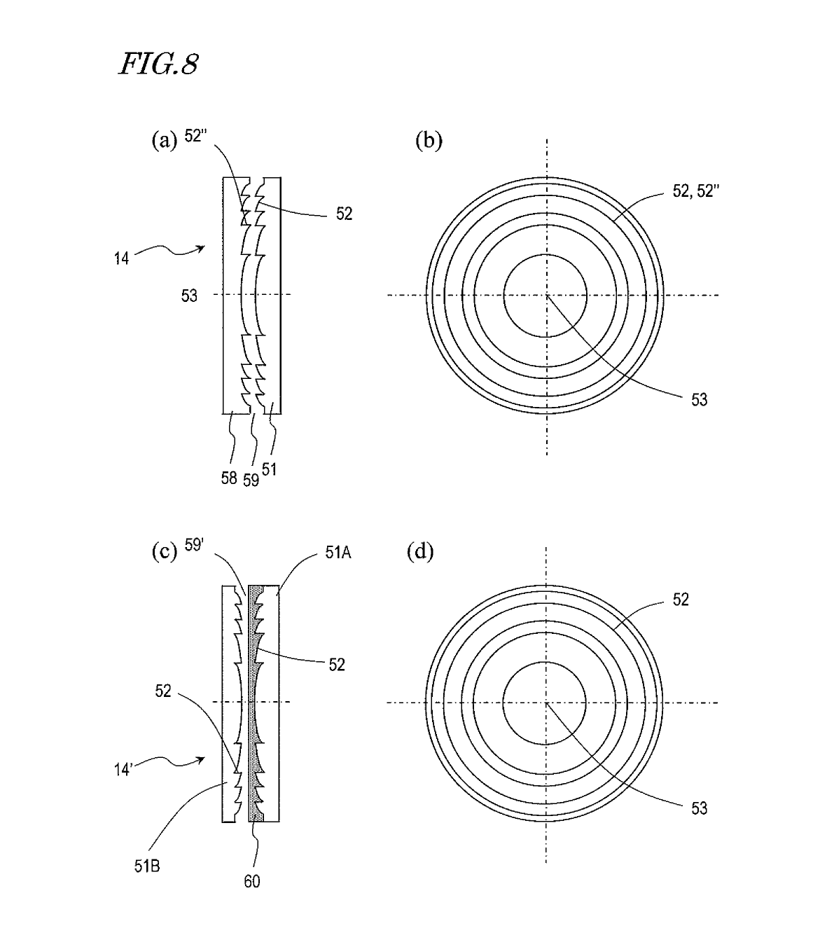

FIG. 8(a) is a schematic cross-sectional view showing an optical system according to an embodiment of the present invention, and FIG. 8(b) is a plan view thereof. An optical element 14 includes the lens base 51 and a lens base 58. The diffraction grating 52 having a structure described above in the first embodiment is provided on one surface of the lens base 51. A diffraction grating 52″ having a shape corresponding to the diffraction grating 52 is provided on the lens base 58. The lens base 51 and the lens base 58 are held with a predetermined gap 59 therebetween.

FIG. 8(c) is a schematic cross-sectional view showing an optical system, etc., according to an embodiment of the present invention, and FIG. 8(d) is a plan view thereof. An optical element 14′ includes a lens base 51A, a lens base 51B, and an optical adjustment film 60. The diffraction grating 52 having a structure described above in the first embodiment is provided on one surface of the lens base 51A. Similarly, the diffraction grating 52 is provided also on the lens base 51B. The optical adjustment film 60 covers the diffraction grating 52 of the lens base 51A. The optical base 51A and the optical base 51B are held so that a gap 59′ is formed between the diffraction grating 52 provided on the surface of the optical base 51B and the optical adjustment film 60.

Also in the optical element 14 and the optical element 14′ each including lens bases provided with diffraction gratings stacked together, the occurrence of fringe flare is suppressed because the diffraction grating 52 is provided as described above in the first embodiment.

### Example 1

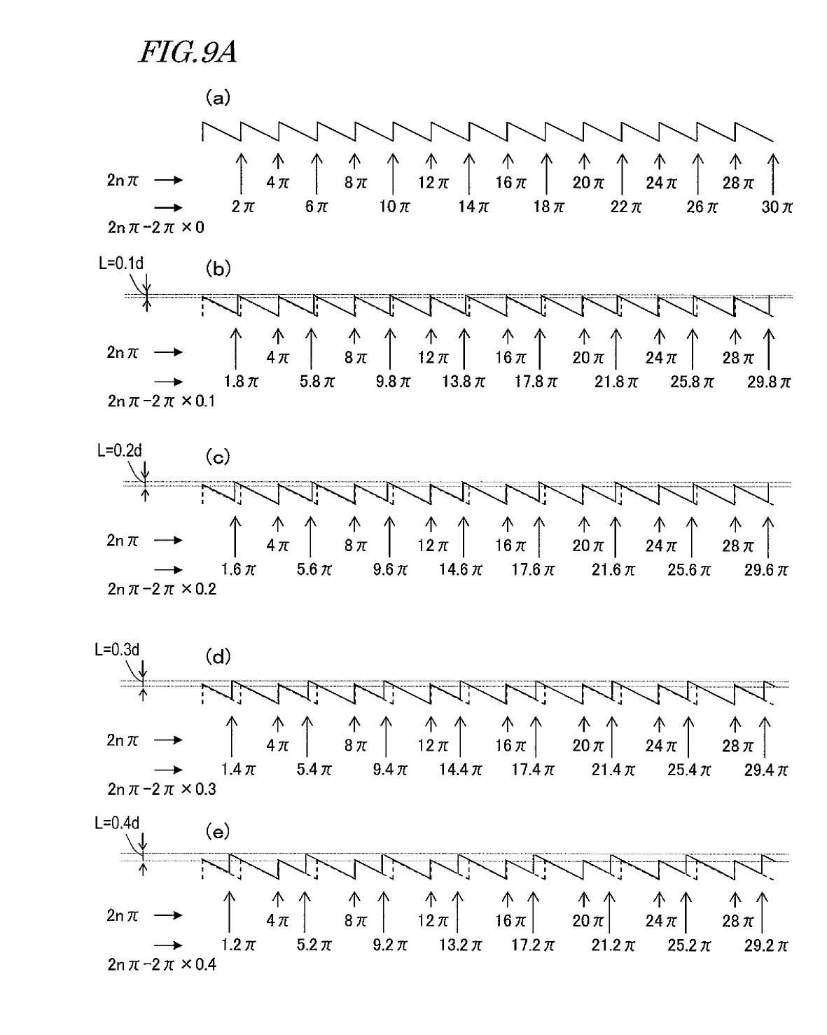

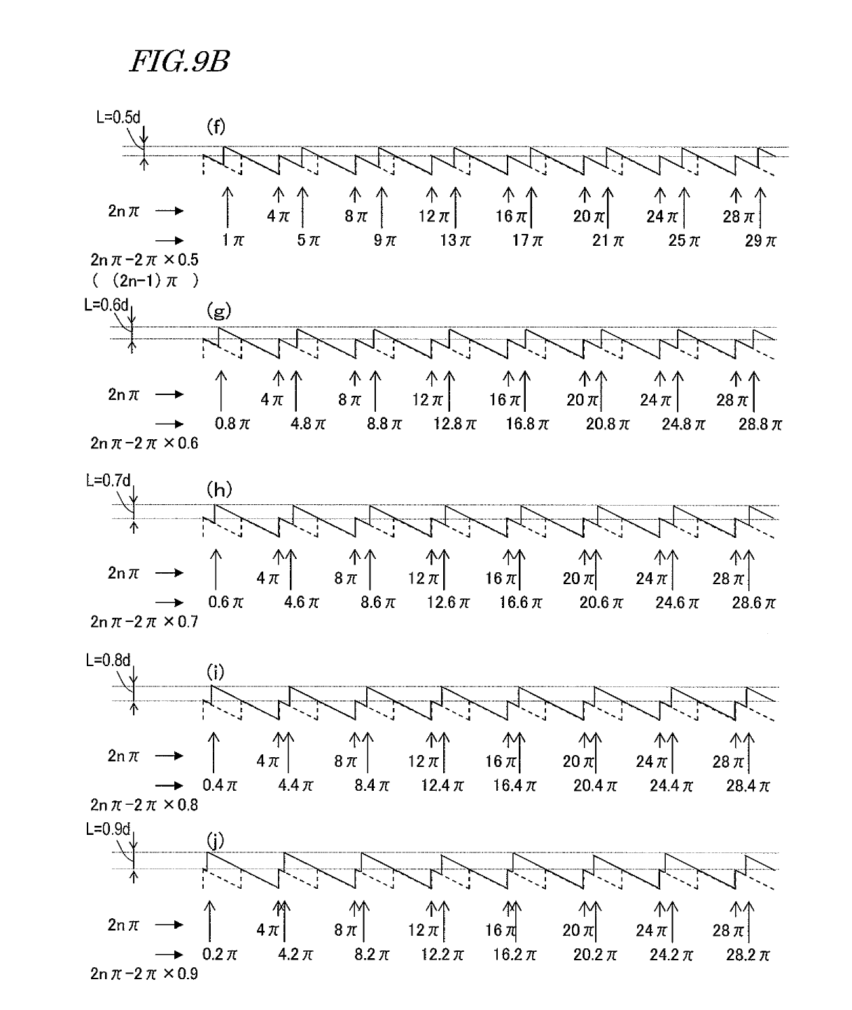

The results of producing the diffraction optical lens 11 of the first embodiment and examining the effect of suppressing the occurrence of fringe flare will be described. In the present example, the diffraction optical lens 11 shown in FIG. 1 was produced, with the diffraction steps 65A provided at positions where the phase difference from the reference point on the phase function is 2 nπ, and the diffraction steps 65B provided at positions where the phase difference is (2 nπ−2π×S). S was varied from 0 to 0.9 in steps of 0.1. The diffraction steps 65A and 65B were arranged so as to alternate with each other. FIGS. 9A(a) to 9A(e) and 9B(f) to 9B(j) schematically show shapes of the diffraction grating when the diffraction steps 65B were provided at positions where the phase difference from the reference point on the phase function was (2 nπ−2π×S) (S=0, 0.1, 0.2, 0.3, 0.4, 0.5, 0.6, 0.7, 0.8, 0.9). Although the zone pitch is shown to be an equal pitch in FIGS. 9A and 98 for the purpose of illustration, a diffraction grating of an actual diffraction grating lens is designed while also using higher-order terms other than a1 of (Expression (1)), and the pitch of diffraction steps varies as shown in FIG. 2(b). The first order was used as the diffraction order. The step height of the diffraction grating of the diffraction grating lens was set to 0.9 mm, the design wavelength and the working wavelength to 538 nm, and the refractive index n₁ of the lens base 51 at the working wavelength to 1.591. The refractive index of the air was assumed to be 1.

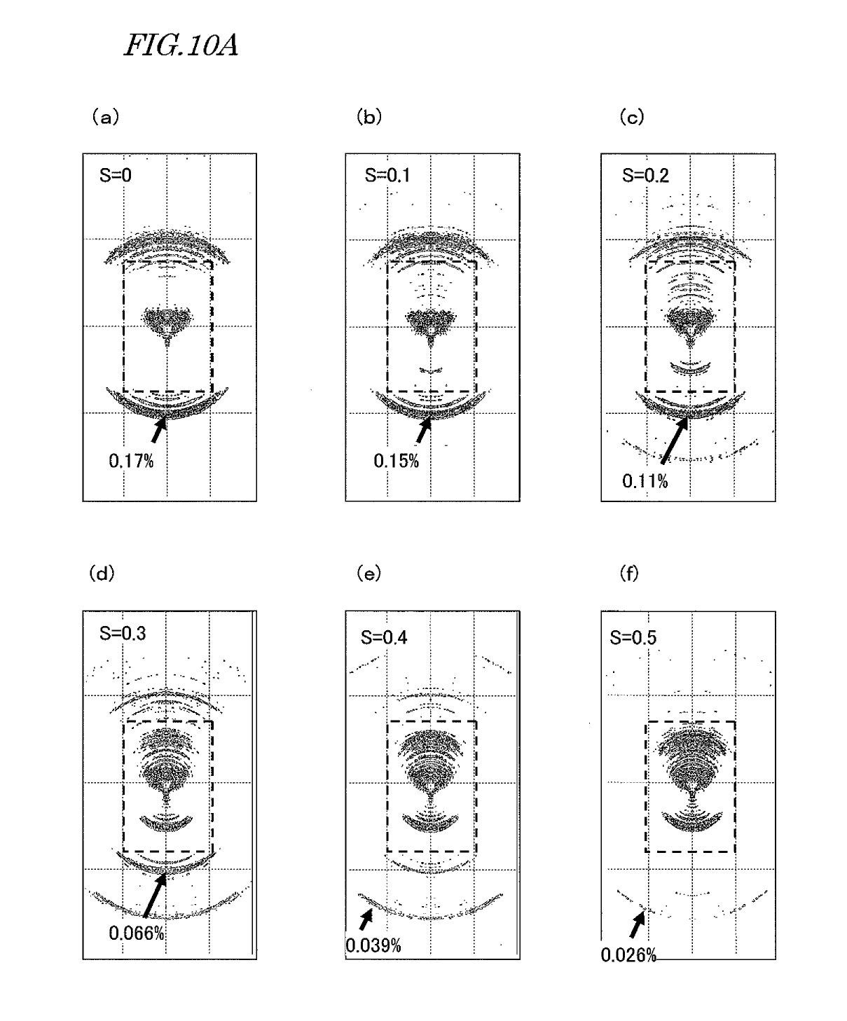

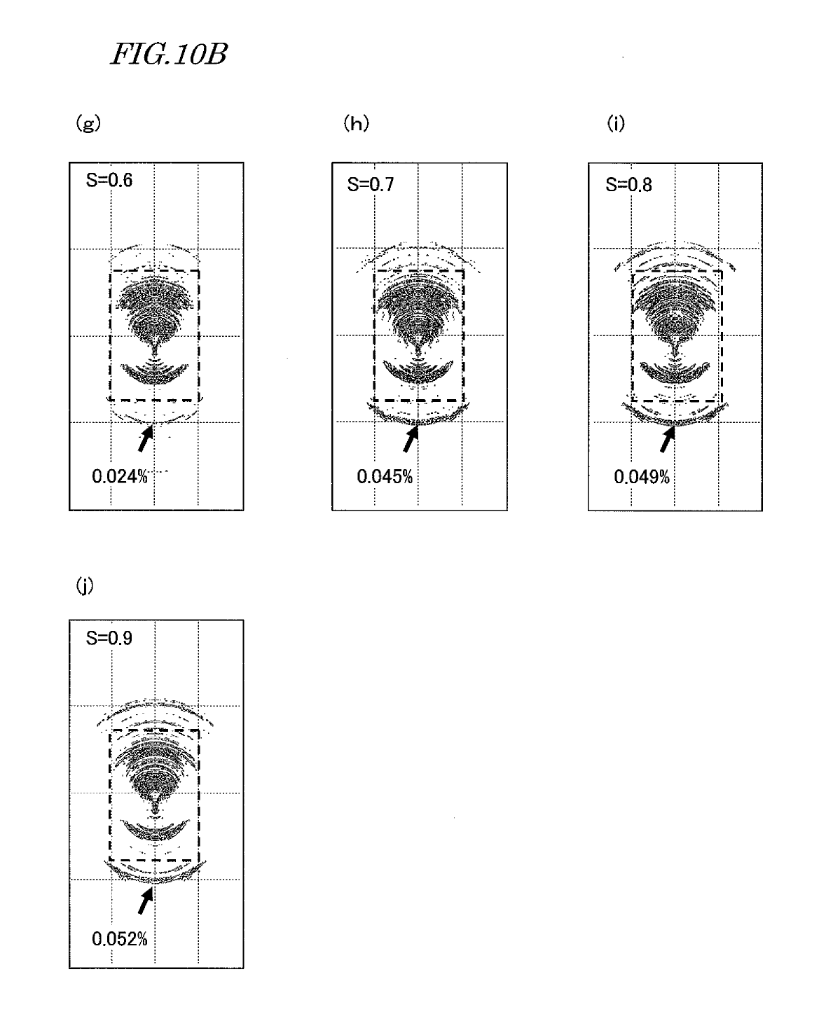

As described above in the first embodiment with reference to FIG. 1(b), when the position at which the diffraction step 65B is provided is shifted from 2 nπ by 2π×S (S=0, 0.1, 0.2, 0.3, 0.4, 0.5, 0.6, 0.7, 0.8, 0.9), the interval L on the optical axis of the diffraction grating 52 between the first surface 66A on which the tips 63A of the zones 61A are located and the second surface 66B on which the tips 63B of the zones 61B are located is d×S (S=0, 0.1, 0.2, 0.3, 0.4, 0.5, 0.6, 0.7, 0.8, 0.9). FIGS. 10A(a) to 10A(f) and FIGS. 10B(g) to 10B(j) each show a two-dimensional image obtained at the focal plane when a plane wave having a wavelength of 538 nm is made to enter diffraction grating lenses having structures shown in FIGS. 9A(a) to 9A(e) and 9B(f) to 9B(j), respectively, from a field angle of 60°.

Of these figures, FIG. 10A(f) is for S=0.5(50%), schematically showing the shape of the diffraction grating in a case where the diffraction steps 65B are provided at positions where the phase difference from the reference point on the phase function is (2 nπ−2π×0.5), i.e., 2(n−1)π. FIG. 10A(f) also shows a two-dimensional image obtained by such a structure. FIG. 10A(a) is for S=0(0%), schematically showing the shape of the conventional diffraction grating where the diffraction steps 65B are provided at positions where the phase difference from the reference point on the phase function is (2 nπ−0), i.e., 2 nπ. FIG. 10A(a) also shows a two-dimensional image obtained by such a structure.

As shown in FIG. 10A(f), fringe flare light is only seen in the central portion, and the amount of flare light from the peripheral portion is successfully reduced. Fringe flare light which has been localized to the central portion will be continuous with the main light and will be less conspicuous. In contrast, as shown in FIG. 10A(a), with a conventional diffraction grating lens, fringe flare light occurs at positions away from the central portion, and extends in a clearly-defined manner. In this case, clearly-defined zones of light exist at positions where they cannot normally occur, and they are therefore conspicuous when one sees the image. The figure shown in the two-dimensional image in FIGS. 10A and 10B is the maximum intensity percentage of fringe flare light. Specifically, assuming that what is within the dotted-line box is the main light and what is outside the dotted-line box is the fringe flare light, it represents the percentage of the maximum value of light intensity outside the dotted-line box with respect to the maximum value of light intensity within the dotted-line box. It can be seen that while the maximum intensity of fringe flare light is 0.17% in FIG. 10A(a), it is successfully reduced to 0.026% in FIG. 10(f). It can be seen from this result that in Example 1, it is possible to localize the fringe flare light to the central portion and significantly reduce the conspicuous flare light in the peripheral portion by providing diffraction steps at positions where the phase difference from the reference point on the phase function is (2 n−1)π. Typically, the zone pitch of a diffraction grating lens narrows toward the periphery of the lens surface, and the zone pitch varies substantially between the center of the lens surface and the peripheral portion thereof. In such a case, there occur fringe flare light with various fringe intervals depending on the zone pitch. However, it is possible to reduce the fringe flare by arranging the diffraction steps at positions of 2 nπ and positions of (2 n−1)π alternately as in Example 1.

As shown in FIGS. 9A(a) to 9A(e) and 9B(f) to 9B(j), the positions of the diffraction steps 65B provided at positions other than 2 nπ also shift as S increases from 0. The diffraction grating lens shape for S=0.9 does not come closer to the shape for S=0, but comes closer to the configuration of a diffraction grating lens of m=2 (the second-order diffraction light is utilized) where the diffraction step height is doubled. Note however that the height of the diffraction steps 65A and 65B is d as described in the first embodiment.

It can be seen from the results shown in FIGS. 10A(a) to 10A(f) and 10B(g) to 10B(j) that the maximum intensity percentage of the fringe flare light decreases as S approaches 0.5 from 0. The maximum intensity percentage of fringe flare light increases as S becomes greater than 0.5.

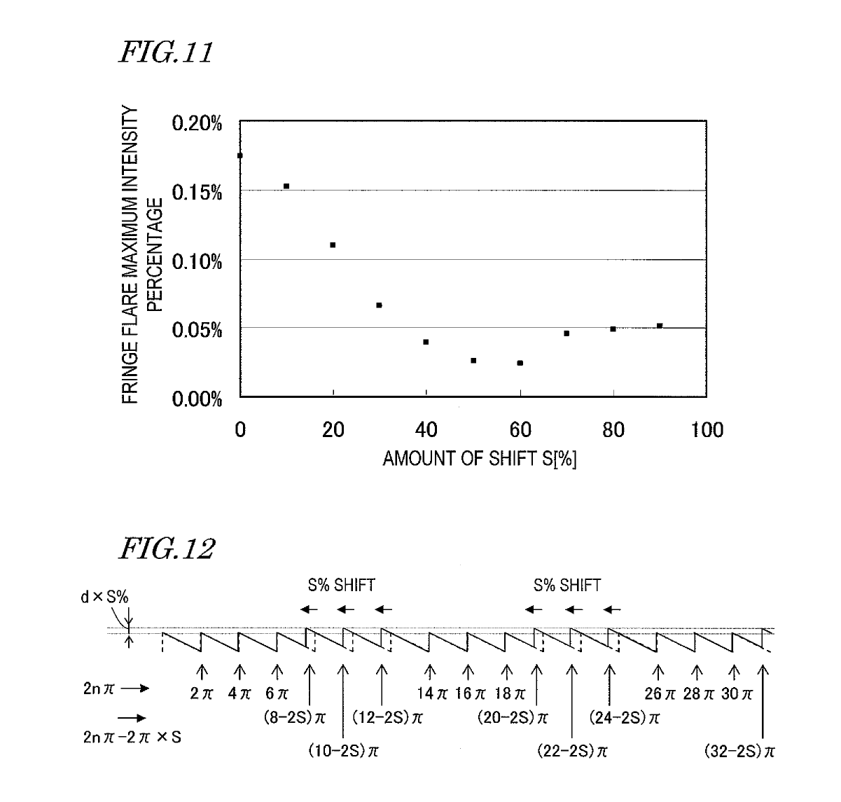

FIG. 11 is a graph summarizing the relationship between the value of S and the maximum intensity percentage of fringe flare light. As can be seen from FIG. 11, by setting the amount of shift S to 0.4 (40%) or more and 0.9 or less, the maximum intensity percentage of fringe flare light is about 0.05% or less, and the fringe flare light can be reduced significantly. More preferably, by setting the amount of shift to 0.4 or more and 0.6 or less, the maximum intensity percentage of fringe flare light can be made 0.04% or less. Most preferably, the amount of shift S is set to 0.5. Then, the fringe flare light outside the dotted-line box can be made less conspicuous as a whole.

Where this condition is represented in terms of the interval L on the optical axis of the diffraction grating 52 between the first surface 66A on which the tips 63A of the zones 61A are located and the second surface 66B on which the tips 63B of the zones 61B are located, the interval L is preferably 0.4d or more and 0.9d or less, and is more preferably 0.4d or more and 0.6d or less, and is most preferably 0.5d. While the direction in which the diffraction step 65B is shifted is left in FIGS. 9A and 9B in the present example, similar results are obtained by shifting in the opposite direction (right).

### Example 2

In the present example, sets of diffraction steps, each set including three diffraction steps consecutively arranged at positions where the phase difference from the reference point on the phase function is (2 nπ−2π×S), and sets of diffraction steps, each set including three diffraction steps consecutively arranged at positions of 2 nπ, are arranged so as to alternate with each other, as shown in FIG. 12. The first order was used as the diffraction order. The step height of the diffraction grating of the diffraction grating lens was set to 0.9 μm, the design wavelength and the working wavelength to 538 nm, and the refractive index n₁ of the lens base 51 at the working wavelength to 1.591. The refractive index of the air was assumed to be 1.

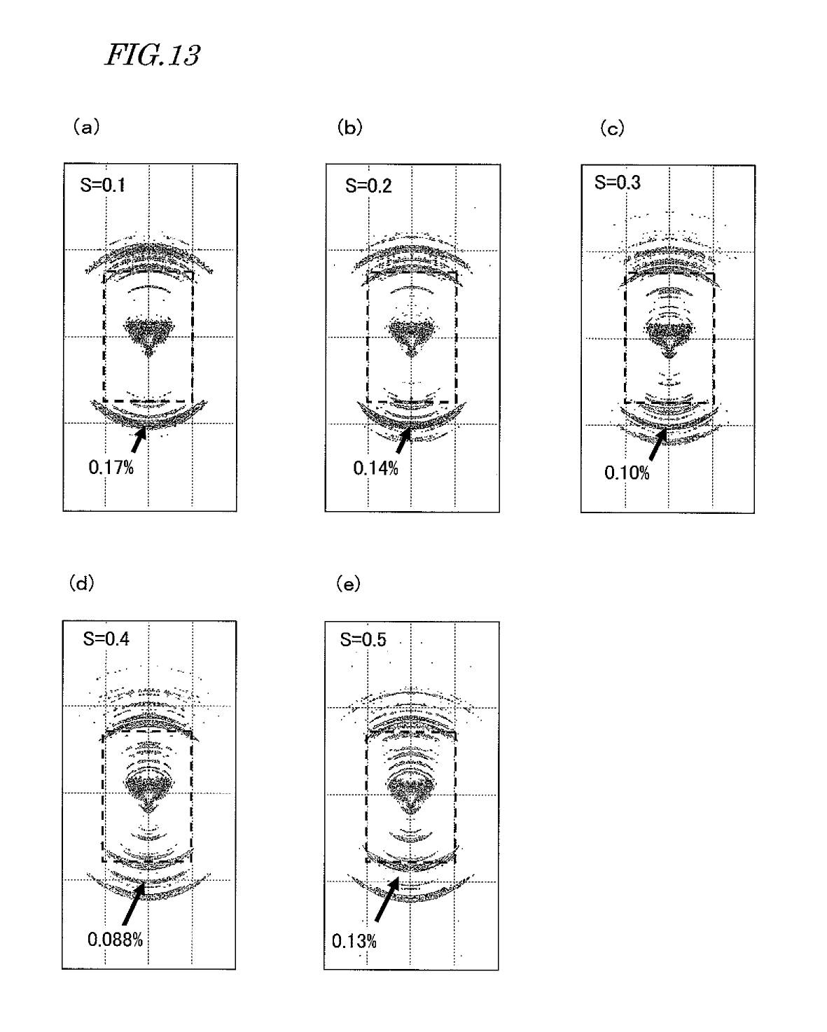

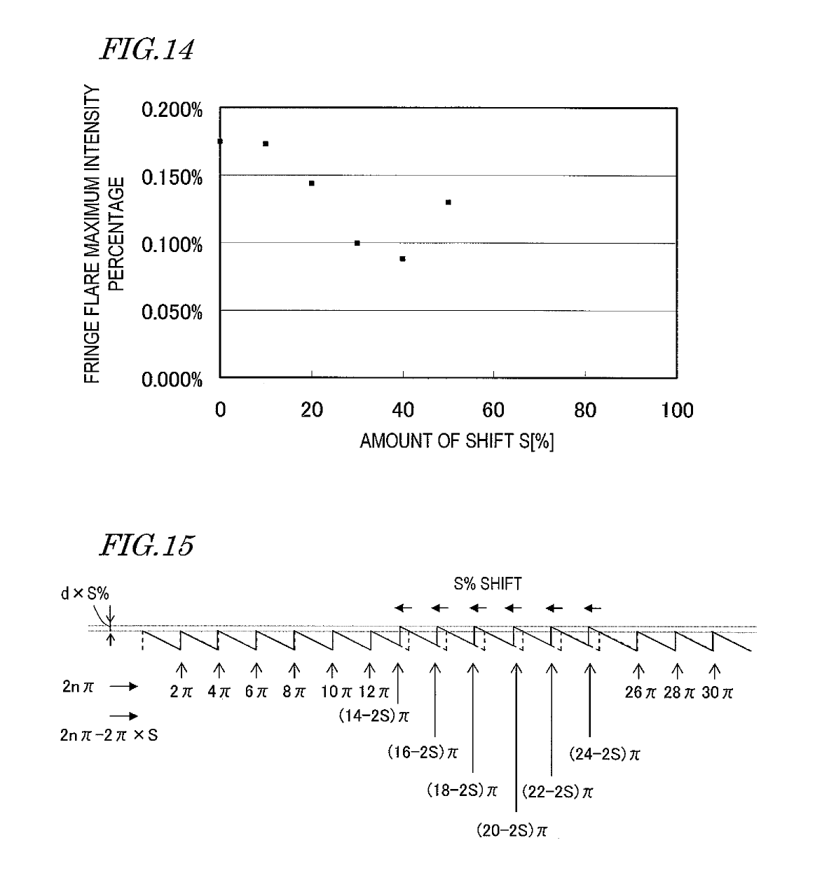

FIGS. 13(a) to 13(e) each show a two-dimensional image obtained at the focal plane when a plane wave having a wavelength of 538 nm is made to enter the diffraction grating lens from a field angle of 60°, where S was varied stepwise from 0.1 to 0.5 in steps of 0.1. FIG. 14 is a graph showing the relationship between the fringe flare maximum intensity percentage and the amount of shift S. It can be seen from FIG. 13 that where the amount of shift S is 0.3 and 0.4, as compared with FIG. 10A(a), the fringe flare light which has resulted in clearly-defined light zones can be dispersed in a well-balanced manner, thereby making the flare less conspicuous in terms of the image quality. It can be seen from FIG. 14 that the maximum intensity percentage of fringe flare is also reduced significantly as compared with comparative examples.

### Example 3

In the present example, sets of diffraction steps, each set including six diffraction steps consecutively arranged at positions where the phase difference from the reference point on the phase function is (2 nπ−2π×S), and sets of diffraction steps, each set including six diffraction steps consecutively arranged at positions of 2 nπ, are arranged so as to alternate with each other, as shown in FIG. 15. The first order was used as the diffraction order. The step height of the diffraction grating of the diffraction grating lens was set to 0.9 μm, the design wavelength and the working wavelength to 538 nm, and the refractive index n₁ of the lens base 51 at the working wavelength to 1.591. The refractive index of the air was assumed to be 1.

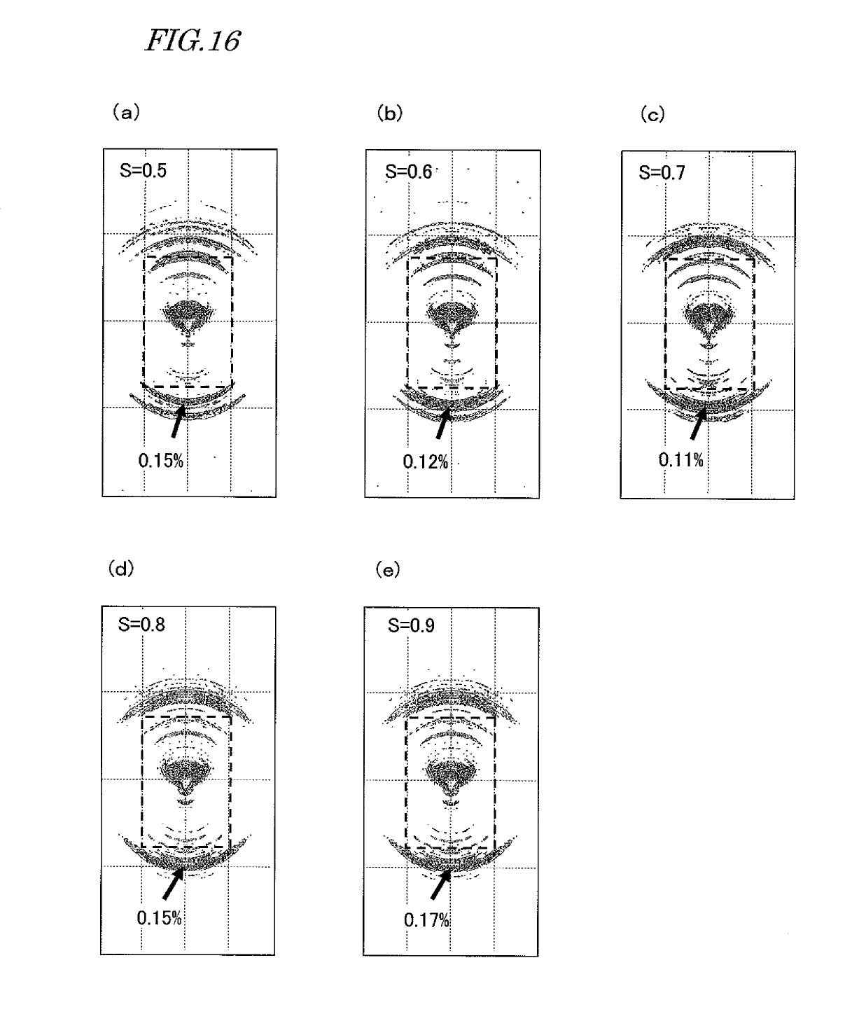

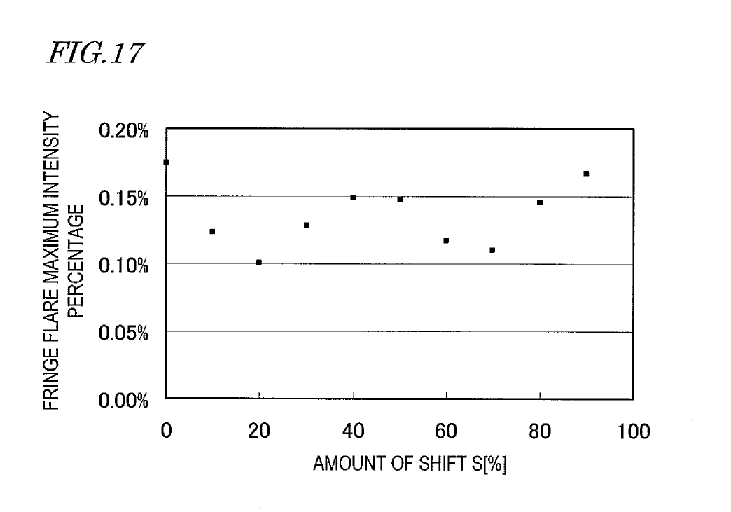

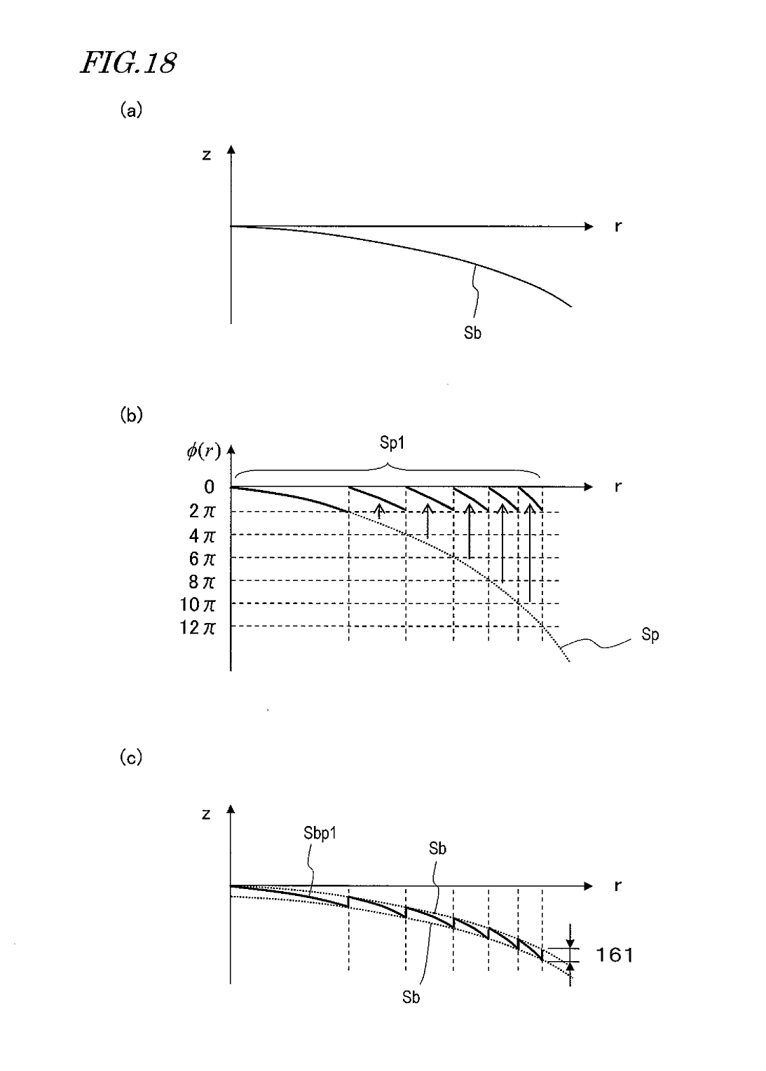

FIGS. 16(a) to 16(e) each show a two-dimensional image obtained at the focal plane when a plane wave having a wavelength of 538 nm is made to enter the diffraction grating lens from a field angle of 60°, where S was varied stepwise from 0.5 to 0.9 in steps of 0.1. FIG. 17 is a graph showing the relationship between the fringe flare maximum intensity percentage and the amount of shift S. The graph of FIG. 17 also shows the results for a case where S is 0.4 or less. It can be seen from FIG. 16 that where the amount of shift S is 0.6 and 0.7, as compared with FIG. 10A(a), the fringe flare light which has resulted in clearly-defined light zones can be dispersed in a well-balanced manner, thereby making the flare less conspicuous in terms of the image quality. It can be seen from FIG. 17 that the maximum intensity percentage of fringe flare is also reduced significantly as compared with comparative examples.

From the graphs of FIGS. 11, 14 and 17, the effect of reducing fringe flare light starts appearing significantly from when the amount of shift S is about 0.1. Therefore, the positions of diffraction steps to be provided at positions where the phase difference from the reference point on the phase function is other than 2 nπ are preferably shifted by 10% or more from 2 nπ. Then, where this condition is represented in terms of the interval L on the optical axis of the diffraction grating 52 between the first surface 66A on which the tips 63A of the zones 61A are located and the second surface 66B on which the tips 63B of the zones 61B are located, the interval L is preferably 0.1d or more.

### INDUSTRIAL APPLICABILITY

The diffraction grating lens of the present invention and the image capture apparatus using the same have the function of reducing fringe flare light and are particularly useful in high-quality cameras.

### REFERENCE SIGNS LIST

11, 12, 12′ Diffraction grating lens
13 Image capture apparatus
14, 14′ Optical element
61A, 62B Zone
65A, 65B Diffraction step
51, 171 Lens base
62 Diaphragm
161, d Step height of diffraction grating
52 Diffraction grating
53 Optical axis
157, 174 Image capture element
175 First-order diffraction light
176 Unnecessary-order diffraction light
181 Optical adjustment film
191 Fringe flare light

1. A diffraction grating lens including a lens base having a surface obtained by providing a diffraction grating on a base shape, wherein:
the diffraction grating includes a plurality of zones in an area within a lens diameter of the lens base, and a plurality of diffraction steps located between the plurality of zones;
the lens base is made of a first material whose refractive index is n₁(λ) at a working wavelength λ;
the plurality of diffraction steps have substantially the same height d;
the height d satisfies Expression (1) below, where m denotes a diffraction order;
$$d = \frac{m \cdot λ}{{n}_{1} ( λ ) - 1} \qquad ( 1 )$$
the plurality of diffraction steps include a plurality of first diffraction steps and at least one second diffraction step adjacent to at least one of the plurality of first diffraction steps;
tips of the plurality of first diffraction steps are located on a first surface obtained by shifting the base shape parallelly in an optical axis direction of the diffraction grating, and a tip of the at least one second diffraction step is located on a second surface obtained by shifting the base shape parallelly in the optical axis direction; and
the first surface and the second surface are at different positions from each other on the optical axis.

2. A diffraction grating lens, comprising:
a lens base having a surface obtained by providing a diffraction grating on a base shape; and
an optical adjustment film provided so as to cover the surface of the lens base, wherein:
the diffraction grating includes a plurality of zones in an area within a lens diameter of the lens base, and a plurality of diffraction steps located between the plurality of zones;
the lens base is made of a first material whose refractive index is n₁(λ) at a working wavelength λ;
the optical adjustment film is made of a second material whose refractive index is n₂(λ) at the working wavelength λ;
the plurality of diffraction steps have substantially the same height d;
the height d satisfies Expression (2) below, where m denotes a diffraction order;
$$d = \frac{m \cdot λ}{{n}_{1} ( λ ) - {n}_{2} ( λ )} \qquad ( 2 )$$
the plurality of diffraction steps include a plurality of first diffraction steps and at least one second diffraction step adjacent to at least one of the plurality of first diffraction steps;
tips of the plurality of first diffraction steps are located on a first surface obtained by shifting the base shape parallelly in an optical axis direction of the diffraction grating, and a tip of the at least one second diffraction step is located on a second surface obtained by shifting the base shape parallelly in the optical axis direction; and
the first surface and the second surface are at different positions from each other on the optical axis.

3. The diffraction grating lens according to claim 1, wherein
the plurality of diffraction steps include a plurality of second diffraction steps; and
the first diffraction steps and the second diffraction steps are arranged so as to alternate with each other.

4. The diffraction grating lens according to claim 1, wherein an interval L on the optical axis between the first surface and the second surface satisfies Expression (3) below.
0.4d≦L≦0.9d (3)

5. The diffraction grating lens according to claim 1, wherein an interval L on the optical axis between the first surface and the second surface satisfies Expression (4) below.
0.4d≦L≦0.6d (4)

6. The diffraction grating lens according to claim 1, wherein an interval L on the optical axis between the first surface and the second surface satisfies L=0.5d.

7. The diffraction grating lens according to claim 1, wherein:
the plurality of diffraction steps include a plurality of second diffraction steps; and
sets of first diffraction steps, each set including i (i is an integer of 2 or more) consecutively-arranged first diffraction steps, and sets of second diffraction steps, each set including j (j is an integer of 2 or more) consecutively-arranged second diffraction steps are arranged so as to alternate with each other.

8. The diffraction grating lens according to claim 2, wherein the working wavelength λ is a wavelength in a visible light range and substantially satisfies Expression (2) for wavelengths across an entire visible light range.

9. A diffraction grating lens including a lens base having a surface obtained by providing a diffraction grating on a base shape, wherein:
the diffraction grating includes a plurality of zones and a plurality of diffraction steps located between the plurality of zones;
the lens base is made of a first material whose refractive index is n₁(λ) at a working wavelength λ;
the plurality of diffraction steps each have a height d represented by Expression (1) below, where m denotes a diffraction order; and
$$d = \frac{m \cdot λ}{{n}_{1} ( λ ) - 1} \qquad ( 1 )$$
the plurality of zones include first, second and third zones adjacent to one another, wherein the second zone is sandwiched between the first and third zones, the first zone and the third zone have generally the same width, and a width of the second zone is narrower than a width of the first zone.

10. An image capture apparatus, comprising:
the diffraction grating lens according to claim 1; and
an image capture element.

11. The diffraction grating lens according to claim 2, wherein
the plurality of diffraction steps include a plurality of second diffraction steps; and
the first diffraction steps and the second diffraction steps are arranged so as to alternate with each other.

12. The diffraction grating lens according to claim 2, wherein an interval L on the optical axis between the first surface and the second surface satisfies Expression (3) below.
0.4d≦L≦0.9d (3)

13. The diffraction grating lens according to claim 2, wherein an interval L on the optical axis between the first surface and the second surface satisfies Expression (4) below.
0.4d≦L≦0.6d (4)

14. The diffraction grating lens according to claim 2, wherein an interval L on the optical axis between the first surface and the second surface satisfies L=0.5d.

15. The diffraction grating lens according to claim 2, wherein:
the plurality of diffraction steps include a plurality of second diffraction steps; and
sets of first diffraction steps, each set including i (i is an integer of 2 or more) consecutively-arranged first diffraction steps, and sets of second diffraction steps, each set including j (j is an integer of 2 or more) consecutively-arranged second diffraction steps are arranged so as to alternate with each other.

16. A diffraction grating lens including a lens base having a surface obtained by providing a diffraction grating on a base shape, wherein:
the diffraction grating includes a plurality of zones and a plurality of diffraction steps located between the plurality of zones;
the lens base is made of a first material whose refractive index is n₁(λ) at a working wavelength λ;
the plurality of diffraction steps each have a height d represented by Expression (2) below, where m denotes a diffraction order; and
$$d = \frac{m \cdot λ}{{n}_{1} ( λ ) - {n}_{2} ( λ )} \qquad ( 2 )$$
the plurality of zones include first, second and third zones adjacent to one another, wherein the second zone is sandwiched between the first and third zones, the first zone and the third zone have generally the same width, and a width of the second zone is narrower than a width of the first zone.
